(19) United States
(12) Patent Application Publication
(10) Pub. No.: US 2021/0258564 A1
(43) Pub. Date: Aug. 19, 2021

(54) PROFILING VIDEO DEVICES

(71) Applicant: safeXai, Inc., Sandy, UT (US)

(72) Inventors: Joshua J. Newman, Park City, UT (US); Ravi Shankar Kannan, Sandy, UT (US); Krishnamohan Pathicherikollamparambil, Salt Lake City, UT (US); Brian Rodriguez, Salt Lake City, UT (US); Spencer R. Moulton, Salt Lake City, UT (US)

(21) Appl. No.: 17/068,307

(22) Filed: Oct. 12, 2020

Related U.S. Application Data
(63) Continuation-in-part of application No. 16/922,235, filed on Jul. 7, 2020.
(60) Provisional application No. 62/897,111, filed on Sep. 6, 2019.

(51) Int. Cl. H04N 17/00; G06K 9/00; H04N 7/18

(52) U.S. Cl. CPC H04N 17/002; H04N 7/18; G06K 9/00744

(57) ABSTRACT

The present invention extends to methods, systems, and computer program products for profiling video output devices. A frameset is received from a video output device. A first characteristic of the frameset is profiled. A focus area within the frameset is identified based on the profile of the first characteristic. A second characteristic is profiled within the focus area. A baseline output profile for the video device is generated based at least on the profile of the second characteristic. The baseline output profile is stored in repository.

### CROSS-REFERENCE TO RELATED APPLICATIONS

This application claims the benefit of U.S. Provisional Patent Application Ser. No. 62/897,111, entitled “Profiling Video Devices”, filed Sep. 6, 2019, which is incorporated herein in its entirety. This application is a continuation-in-part of U.S. patent application Ser. No. 16/922,235, entitled “Segmenting Video Stream Frames”, filed Jul. 7, 2020, which is incorporated herein in its entirety.

### BACKGROUND

### 1. Background and Relevant Art

Entities (e.g., parents, guardians, friends, relatives, teachers, social workers, first responders, hospitals, delivery services, media outlets, government entities, etc.) may desire to be made aware of relevant events (e.g., fires, accidents, police presence, shootings, etc.) as close as possible to the events' occurrence. However, entities typically are not made aware of an event until after a person observes the event (or the event aftermath) and calls authorities.

In general, techniques that attempt to automate event detection are unreliable. Some techniques have attempted to mine social media data to detect the planning of events and forecast when events might occur. However, events can occur without prior planning and/or may not be detectable using social media data. Further, these techniques are not capable of meaningfully processing available data nor are these techniques capable of differentiating false data (e.g., hoax social media posts)

Other techniques use textual comparisons to compare textual content (e.g., keywords) in a data stream to event templates in a database. If text in a data stream matches keywords in an event template, the data stream is labeled as indicating an event.

Additional techniques use event specific sensors to detect specified types of event. For example, earthquake detectors can be used to detect earthquakes.

It may be that evidence of an event is contained in video. Video may be recorded video, for example, captured at a smart phone camera, that is uploaded in some way for viewing by others. Alternately, video can be live streaming video, for example, streaming from a smart phone camera, a traffic camera, another other public camera, or a private camera.

Typical multi-camera systems are deployed and monitored by the same entity. When monitoring is provided by the same entity that deployed the cameras, a greater degree of access and control features are available during monitoring. For example, it is easier to control the types of cameras being used and/or the orientation of the cameras.

However, it may be desirable to have an entity other than the deploying entity monitor camera feeds. Additionally, the monitoring entity may have a need to simultaneously monitor video feeds from many different deploying entities that have each deployed different types of cameras. In some instances, it may be desirable to combine output from multiple different deployed systems that are each managed by a different entity. Combining outputs can cause issues with creating consistent monitoring output across the different systems. Even within a single deployed system, over time, the deployed devices may vary as video devices are updated, replaced, moved, degrade, or otherwise changed. Thus, even within a single system, monitoring requirements may change over time.

Some systems address configuration changes, for example, establishing a lowest-capability metric that treats all devices as if they are the least capable device in the whole system. In this way, monitoring activities are more likely to be successful across the entire system. However, this solution underutilizes more capable devices and results in lower quality monitoring output.

In other solutions, lower capability devices may be removed or unallocated within monitoring activities when they are determined to be unable to provide high quality monitoring. Again, this solution results in reducing the overall capability of a monitoring environment.

### BRIEF SUMMARY

Examples extend to methods, systems, and computer program products for profiling video devices. A frameset is received from a video output device. A first characteristic of the frameset is profiled. A focus area within the frameset is identified based on the profile of the first characteristic. A second characteristic is profiled within the focus area. A baseline output profile for the video device is generated based at least on the profile of the second characteristic. The baseline output profile is stored in repository.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1A illustrates an example computer architecture that facilitates ingesting signals.

FIG. 1B illustrates an example computer architecture that facilitates detecting events.

FIG. 2 illustrates a flow chart of an example method for normalizing ingested signals.

FIGS. 3A, 3B, and 3C illustrate other example components that can be included in signal ingestion modules.

FIG. 4 illustrates a flow chart of an example method for normalizing an ingested signal including time information, location information, and context information.

FIG. 5 illustrates a flow chart of an example method for normalizing an ingested signal including time information and location information.

FIG. 6 illustrates a flow chart of an example method for normalizing an ingested signal including time information.

FIGS. 7A-7E illustrate a computer architecture that facilitates segmenting video stream frames.

FIG. 8 illustrates a flow chart of an example method for segmenting video stream frames.

FIG. 9A depicts an example frame from a traffic camera.

FIG. 9B depicts an example color mask associated with the example frame of FIG. 9A.

FIG. 9C depicts an example binary mask for the example frame of FIG. 9A.

FIG. 9D depicts an example of the binary mask of FIG. 9C applied to a frame similar to the frame in FIG. 9A.

FIG. 9E depicts an example inverse binary mask for the example frame of FIG. 9A.

FIG. 9F depicts an example of the inverse binary mask of FIG. 9E applied to a frame similar to the frame in FIG. 9A.

FIG. 10 illustrates a computer architecture that facilitates video device profiling.

FIG. 11 illustrates an example camera system.

FIG. 12 illustrates an example processing pipeline.

FIG. 13A illustrates an example computer architecture that facilitates video device profiling.

FIG. 13B illustrates an example partial profiling sequence using components of FIG. 13A.

FIG. 13C illustrates another partial profiling sequence using components of FIG. 13A.

FIG. 14A illustrates an example video output frame.

FIG. 14B illustrates another example video output frame.

FIG. 14C illustrates a further example video output frame.

FIG. 14D illustrates an additional example video output frame.

FIG. 14E illustrates another additional example video output frame.

FIG. 14F illustrates another further example video output frame.

FIG. 14G illustrates a further additional example video output frame.

FIG. 15 illustrates an example computer architecture that facilitates profiling at intervals.

FIG. 16 illustrates an example computer architecture that facilitates seeding a camera metadata repository.

FIG. 17 illustrates an example computer architecture that facilitates producing output from a pipeline.

FIG. 18 illustrates a flow chart of an example method for determining video output device sufficiency for a pipeline.

FIG. 19 illustrates a flow chart of an example method for determining if video device reprofiling is appropriate.

FIG. 20 illustrates a flow chart of an example method for applying partially sequenced video profiling.

FIG. 21 illustrates a flow chart of an example method for applying a mutually exclusive profiling condition associated with a video device.

### DETAILED DESCRIPTION

Examples extend to methods, systems, and computer program products for profiling video devices.

When considering a video stream, it may be that some portions of the video stream are less relevant (and possibly irrelevant). For example, in a traffic camera video stream, portions including roadway may be more relevant and portions not including roadway may be less relevant. However, full frames of the video stream may none the less be processed even through portions of the frames are of limited (if any) relevance. Processing portions of a video stream having limited relevance is an inefficient use of resources. Processing portions of a video stream having limited relevance also makes tasks (e.g., event detection) more complex/difficult as there is more information to process and understand.

As such, aspects of the invention segment video stream frames. In one aspect, video stream frames are segmented into more relevant segments (e.g., including roadway) and less relevant segments (e.g., not including roadway). Different segments can be handled differently. For example, more relevant segments can be processed to identify vehicles, identify events, etc. and less relevant segments may be ignored. Accordingly, resources can be utilized more efficiently.

In some aspects, multi-device and multi-entity monitoring environments benefit from the systems and methods described herein for profiling individual video and/or image capture devices and then selecting processing pipelines for each device based on their present monitoring capabilities.

As such, video profiling/calibrating systems and methods are described herein. As described, video device profiling can include determining the present state of a video device, including both inherent characteristics of a video device (e.g., resolution, framerate, etc.) and/or present configuration of the video device (e.g., orientation, location, etc.). Calibration can include altering the present state or configuration of a video device in order to affect its output characteristics in some manner.

Further, understanding the present state and output capabilities of a video device cannot necessarily be determined by knowing the original or stated inherent specifications of the video device or by knowing the present user configuration of the video device. Instead, profiling can be improved by analyzing present video output to determine present output characteristics. Further, comparing current output characteristics to prior outputs may also be beneficial in understanding the comparative quality of the device output.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: raw signals, social signals, Web signals, streaming signals, normalized signals, events, search terms, geo cell data, geo cell subsets, event notifications, video streams, frames, sprites, vectors, objects, objects types, assigned colors, color mappings, color masks, defined object relationships, object subsets, reassigned colors, aggregate color masks, binary masks, masked frames, pipelines, camera metadata, GPU/CPU output, pipeline output, object detections, color detections, confidence thresholds, scenes, qualities, segments, day/night, weather, orientation, samples, baseline profiles, refence frame sets, pipeline confidence scores, profile scores, camera details, camera IDs, pipeline categories, video output streams, etc.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: raw signals, social signals, Web signals, streaming signals, normalized signals, events, search terms, geo cell data, geo cell subsets, event notifications, video streams, frames, sprites, vectors, objects, objects types, assigned colors, color mappings, color masks, defined object relationships, object subsets, reassigned colors, aggregate color masks, binary masks, masked frames, pipelines, camera metadata, GPU/CPU output, pipeline output, object detections, color detections, confidence thresholds, scenes, qualities, segments, day/night, weather, orientation, samples, baseline profiles, refence frame sets, pipeline confidence scores, profile scores, camera details, camera IDs, pipeline categories, video output streams, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, a “pipeline” is defined as a sequence of processing instructions or activities that can be applied to a data stream, such as a video stream. Pipelines may be organized into categories. Pipelines may also be configured, such that within a pipeline category, multiple versions of a pipeline may exist, for example, to allow for different processing levels of the pipeline.

In this description and the following claims, “profiling” is defined as determining one or more characteristics of a data stream and/or a device by identifying or determining the nature of particular elements of the data stream and/or device. Profiling can include analyzing the raw content of a data stream or other data or metadata attached to, transmitted along with, or otherwise associated with the raw content. Profiling may also include analyzing other information indirectly known, received, or detected about the raw content or the system(s) or device(s) from which the raw content originated.

In this description and the following claims, a “profile score” is defined as a value given to an element identified through profiling. In some cases, a profile score is a single value for a single profiling element, and in other cases a profile score may be an aggregation of one or more values corresponding to different profiling elements. For example, some profile scores may be for elements such as video stream quality, resolution, motion quality, blur quality, etc. Other profile scores may be linked to elements such as luminance value (e.g., day or night), weather events, scene type, etc.

In this description and the following claims, a “confidence score” is defined as a calculated value derived through one or more profile scores that indicates whether and/or to what degree a particular data stream or data device is sufficient or appropriate to use for a given pipeline. In some instances, a data stream or a data device may receive multiple confidence scores representing the sufficiency or appropriateness of using that stream/device for use in different pipelines.

In this description and the following claims, a “master sprite(s)” is defined as a (e.g., single) raw output frame from a video device or to a frame collection or frameset comprising a plurality of raw output frames from the video device.

In this description and the following claims, a “partial profiling sequence” is defined as profiling when at least one profiling (e.g., data) element is proactively selected to occur prior to at least one other profiling (e.g., data) element.

In this description and the following claims, a “geo cell” is defined as a piece of “cell” in a grid in any form. In one aspect, geo cells are arranged in a hierarchical structure. Cells of different geometries can be used.

A “geohash” is an example of a “geo cell”.

In this description and the following claims, “geohash” is defined as a geocoding system which encodes a geographic location into a short string of letters and digits. Geohash is a hierarchical spatial data structure which subdivides space into buckets of grid shape (e.g., a square). Geohashes offer properties like arbitrary precision and the possibility of gradually removing characters from the end of the code to reduce its size (and gradually lose precision). As a consequence of the gradual precision degradation, nearby places will often (but not always) present similar prefixes. The longer a shared prefix is, the closer the two places are. geo cells can be used as a unique identifier and to represent point data (e.g., in databases).

In one aspect, a “geohash” is used to refer to a string encoding of an area or point on the Earth. The area or point on the Earth may be represented (among other possible coordinate systems) as a latitude/longitude or Easting/Northing—the choice of which is dependent on the coordinate system chosen to represent an area or point on the Earth. geo cell can refer to an encoding of this area or point, where the geo cell may be a binary string comprised of 0s and 1s corresponding to the area or point, or a string comprised of 0s, 1s, and a ternary character (such as X)—which is used to refer to a don't care character (0 or 1). A geo cell can also be represented as a string encoding of the area or point, for example, one possible encoding is base-32, where every 5 binary characters are encoded as an ASCII character.

Depending on latitude, the size of an area defined at a specified geo cell precision can vary. In one example, as shown in Table 1. the areas defined at various geo cell precisions are approximately:

TABLE 1
Example Areas at Various Geo Cell Precisions

| geo cell Length/Precision | width × height |
|---|---|
| 1 | 5,009.4 km × 4,992.6 km |
| 2 | 1,252.3 km × 624.1 km |
| 3 | 156.5 km × 156 km |
| 4 | 39.1 km × 19.5 km |
| 5 | 4.9 km × 4.9 km |
| 6 | 1.2 km × 609.4 m |
| 7 | 152.9 m × 152.4 m |
| 8 | 38.2 m × 19 m |
| 9 | 4.8 m × 4.8 m |
| 10 | 1.2 m × 59.5 cm |
| 11 | 14.9 cm × 14.9 cm |
| 12 | 3.7 cm × 1.9 cm |

Other geo cell geometries can include hexagonal tiling, triangular tiling, and/or any other suitable geometric shape tiling. For example, the H3 geospatial indexing system can be a multi-precision hexagonal tiling of a sphere (e.g., the Earth) indexed with hierarchical linear indexes.

In another aspect, geo cells are a hierarchical decomposition of a sphere (such as the Earth) into representations of regions or points based a Hilbert curve (e.g., the S2 hierarchy or other hierarchies). Regions/points of the sphere can be projected into a cube and each face of the cube includes a quad-tree where the sphere point is projected into. After that, transformations can be applied and the space discretized. The geo cells are then enumerated on a Hilbert Curve (a space-filling curve that converts multiple dimensions into one dimension and preserves the approximate locality).

Due to the hierarchical nature of geo cells, any signal, event, entity, etc., associated with a geo cell of a specified precision is by default associated with any less precise geo cells that contain the geo cell. For example, if a signal is associated with a geo cell of precision 9, the signal is by default also associated with corresponding geo cells of precisions 1, 2, 3, 4, 5, 6, 7, and 8. Similar mechanisms are applicable to other tiling and geo cell arrangements. For example, S2 has a cell level hierarchy ranging from level zero (85,011,012 km²) to level 30 (between 0.48 cm² to 0.96 cm²).

Signal Ingestion and Normalization

Signal ingestion modules can ingest a variety of raw structured and/or raw unstructured signals on an on going basis and in essentially real-time. Raw signals can include social posts, live broadcasts, traffic camera feeds, other camera feeds (e.g., from other public cameras or from CCTV cameras), listening device feeds, 911 calls, weather data, planned events, IoT device data, crowd sourced traffic and road information, satellite data, air quality sensor data, smart city sensor data, public radio communication (e.g., among first responders and/or dispatchers, between air traffic controllers and pilots), subscription data services, etc.

Raw signals can include different data media types and different data formats, including social signals, Web signals, and streaming signals. Data media types can include audio, video, image, and text. Different formats can include text in XML, text in JavaScript Object Notation (JSON), text in RSS feed, plain text, video stream in Dynamic Adaptive Streaming over HTTP (DASH), video stream in HTTP Live Streaming (HLS), video stream in Real-Time Messaging Protocol (RTMP), other Multipurpose Internet Mail Extensions (MIME) types, etc. Handling different types and formats of data introduces inefficiencies into subsequent event detection processes, including when determining if different signals relate to the same event.

Accordingly, signal ingestion modules can normalize (e.g., prepare or pre-process) raw signals into normalized signals to increase efficiency and effectiveness of subsequent computing activities, such as, event detection, event notification, etc., that utilize the normalized signals. For example, signal ingestion modules can normalize raw signals into normalized signals having a Time, Location, and Context (TLC) dimensions. An event detection infrastructure can use the Time, Location, and Content dimensions to more efficiently and effectively detect events.

A Time (T) dimension can include a time of origin or alternatively a “event time” of a signal. A Location (L) dimension can include a location anywhere across a geographic area, such as, a country (e.g., the United States), a State, a defined area, an impacted area, an area defined by a geo cell, an address, etc.

A Context (C) dimension indicates circumstances surrounding formation/origination of a raw signal in terms that facilitate understanding and assessment of the raw signal. The Context (C) dimension of a raw signal can be derived from express as well as inferred signal features of the raw signal.

Per signal type and signal content, different normalization modules can be used to extract, derive, infer, etc. Time, Location, and Context dimensions from/for a raw signal. For example, one set of normalization modules can be configured to extract/derive/infer Time, Location and Context dimensions from/for social signals. Another set of normalization modules can be configured to extract/derive/infer Time, Location and Context dimensions from/for Web signals. A further set of normalization modules can be configured to extract/derive/infer Time, Location and Context dimensions from/for streaming signals.

Normalization modules for extracting/deriving/inferring Time, Location, and Context dimensions can include text processing modules, NLP modules, image processing modules, video processing modules, etc. The modules can be used to extract/derive/infer data representative of Time, Location, and Context dimensions for a signal. Time, Location, and Context dimensions for a signal can be extracted/derived/inferred from metadata and/or content of the signal.

For example, NLP modules can analyze metadata and content of a sound clip to identify a time, location, and keywords (e.g., fire, shooter, etc.). An acoustic listener can also interpret the meaning of sounds in a sound clip (e.g., a gunshot, vehicle collision, etc.) and convert to relevant context. Live acoustic listeners can determine the distance and direction of a sound. Similarly, image processing modules can analyze metadata and pixels in an image to identify a time, location and keywords (e.g., fire, shooter, etc.). Image processing modules can also interpret the meaning of parts of an image (e.g., a person holding a gun, flames, a store logo, etc.) and convert to relevant context. Other modules can perform similar operations for other types of content including text and video.

Per signal type, each set of normalization modules can differ but may include at least some similar modules or may share some common modules. For example, similar (or the same) image analysis modules can be used to extract named entities from social signal images and public camera feeds. Likewise, similar (or the same) NLP modules can be used to extract named entities from social signal text and web text.

In some aspects, an ingested signal includes sufficient expressly defined time, location, and context information upon ingestion. The expressly defined time, location, and context information is used to determine Time, Location, and Context dimensions for the ingested signal. In other aspects, an ingested signal lacks expressly defined location information or expressly defined location information is insufficient (e.g., lacks precision) upon ingestion. In these other aspects, Location dimension or additional Location dimension can be inferred from features of an ingested signal and/or through references to other data sources. In further aspects, an ingested signal lacks expressly defined context information or expressly defined context information is insufficient (e.g., lacks precision) upon ingestion. In these further aspects, Context dimension or additional Context dimension can be inferred from features of an ingested signal and/or through reference to other data sources.

In further aspects, time information may not be included, or included time information may not be given with high enough precision and Time dimension is inferred. For example, a user may post an image to a social network which had been taken some indeterminate time earlier.

Normalization modules can use named entity recognition and reference to a geo cell database to infer Location dimension. Named entities can be recognized in text, images, video, audio, or sensor data. The recognized named entities can be compared to named entities in geo cell entries. Matches indicate possible signal origination in a geographic area defined by a geo cell.

As such, a normalized signal can include a Time dimension, a Location dimension, a Context dimension (e.g., single source probabilities and probability details), a signal type, a signal source, and content.

A single source probability can be calculated by single source classifiers (e.g., machine learning models, artificial intelligence, neural networks, statistical models, etc.) that consider hundreds, thousands, or even more signal features (dimensions) of a signal. Single source classifiers can be based on binary models and/or multi-class models.

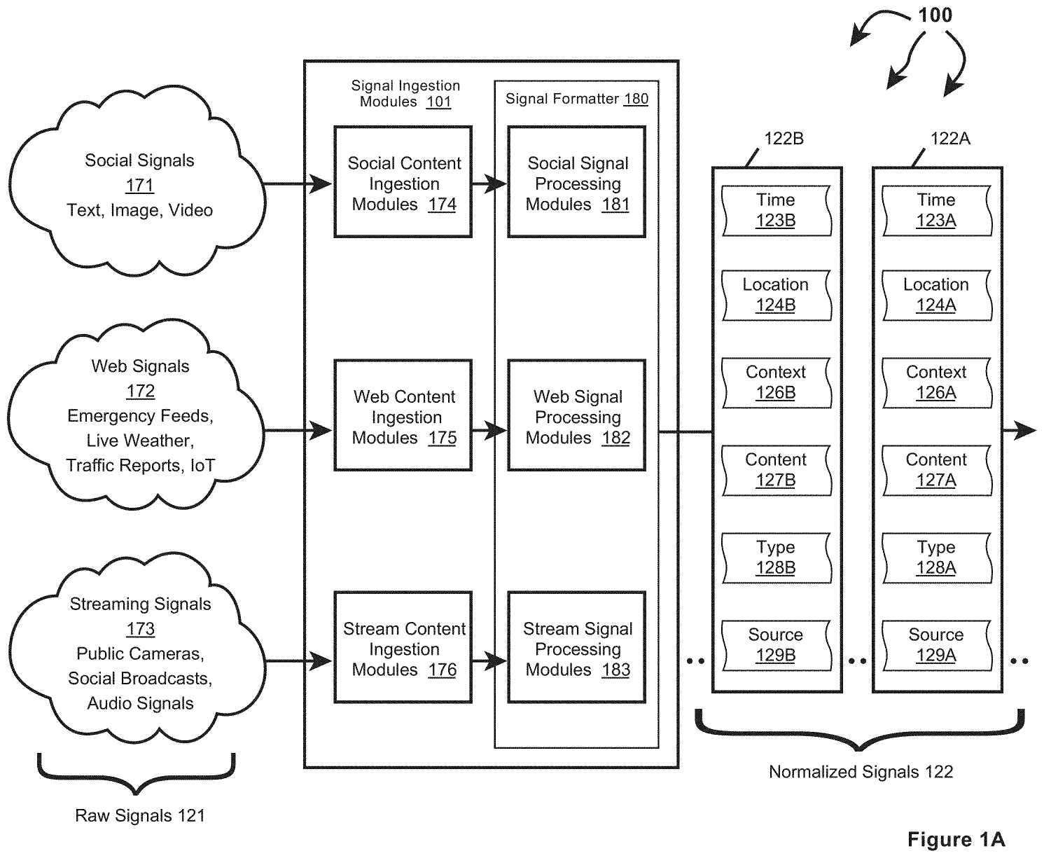

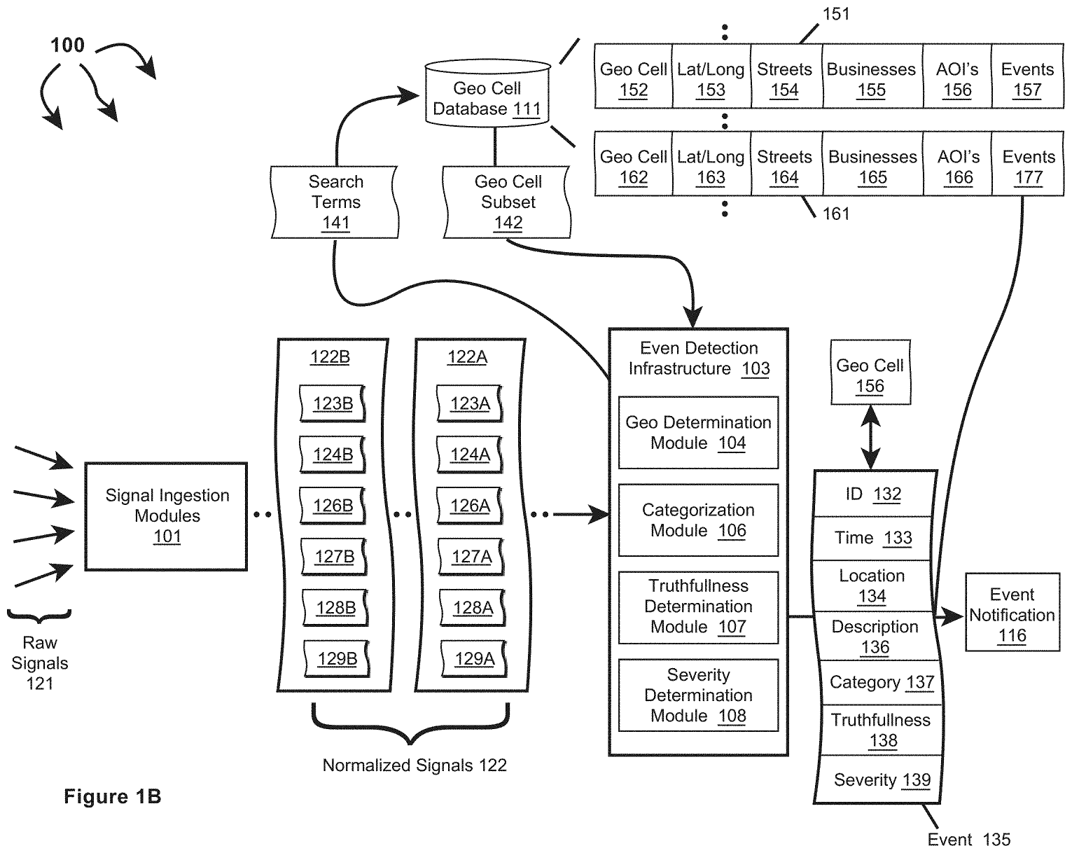

FIG. 1A depicts part of computer architecture 100 that facilitates ingesting and normalizing signals. As depicted, computer architecture 100 includes signal ingestion modules 101, social signals 171, Web signals 172, and streaming signals 173. Signal ingestion modules 101, social signals 171, Web signals 172, and streaming signals 173 can be connected to (or be part of) a network, such as, for example, a system bus, a Local Area Network (“LAN”), a Wide Area Network (“WAN”), and even the Internet. Accordingly, signal ingestion modules 101, social signals 171, Web signals 172, and streaming signals 173 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Signal ingestion module(s) 101 can ingest raw signals 121, including social signals 171, web signals 172, and streaming signals 173, on an on going basis and in essentially real-time. Raw signals 121 can include social posts, recorded videos, streaming videos, traffic camera feeds, other camera feeds, listening device feeds, 911 calls, weather data, planned events, IoT device data, crowd sourced traffic and road information, satellite data, air quality sensor data, smart city sensor data, public radio communication, subscription data service data, etc. As such, potentially thousands, millions or even billions of unique raw signals, each with unique characteristics, are can be ingested and used determine event characteristics, such as, event truthfulness, event severity, event category or categories, etc.

Signal ingestion module(s) 101 include social content ingestion modules 174, web content ingestion modules 176, stream content ingestion modules 176, and signal formatter 180. Signal formatter 180 further includes social signal processing module 181, web signal processing module 182, and stream signal processing modules 183.

For each type of signal, a corresponding ingestion module and signal processing module can interoperate to normalize the signal into a Time, Location, Context (TLC) dimensions. For example, social content ingestion modules 174 and social signal processing module 181 can interoperate to normalize social signals 171 into TLC dimensions. Similarly, web content ingestion modules 176 and web signal processing module 182 can interoperate to normalize web signals 172 into TLC dimensions. Likewise, stream content ingestion modules 176 and stream signal processing modules 183 can interoperate to normalize streaming signals 173 into TLC dimensions.

In one aspect, signal content exceeding specified size requirements (e.g., audio or video) is cached upon ingestion. Signal ingestion modules 101 include a URL or other identifier to the cached content within the context for the signal.

In one aspect, signal formatter 180 includes modules for determining a single source probability as a ratio of signals turning into events based on the following signal properties: (1) event class (e.g., fire, accident, weather, etc.), (2) media type (e.g., text, image, audio, etc.), (3) source (e.g., twitter, traffic camera, first responder radio traffic, etc.), and (4) geo type (e.g., geo cell, region, or non-geo). Probabilities can be stored in a lookup table for different combinations of the signal properties. Features of a signal can be derived and used to query the lookup table. For example, the lookup table can be queried with terms (“accident”, “image”, “twitter”, “region”). The corresponding ratio (probability) can be returned from the table.

In another aspect, signal formatter 180 includes a plurality of single source classifiers (e.g., artificial intelligence, machine learning modules, neural networks, etc.). Each single source classifier can consider hundreds, thousands, or even more signal features (dimensions) of a signal. Signal features of a signal can be derived and submitted to a signal source classifier. The single source classifier can return a probability that a signal indicates a type of event. Single source classifiers can be binary classifiers or multi-source classifiers.

Raw classifier output can be adjusted to more accurately represent a probability that a signal is a “true positive”. For example, 1,000 signals whose raw classifier output is 0.9 may include 80% as true positives. Thus, probability can be adjusted to 0.8 to reflect true probability of the signal being a true positive. “Calibration” can be done in such a way that for any “calibrated score” this score reflects the true probability of a true positive outcome.

Signal ingestion modules 101 can insert one or more single source probabilities and corresponding probability details into a normalized signal to represent a Context (C) dimension. Probability details can indicate a probabilistic model and features used to calculate the probability. In one aspect, a probabilistic model and signal features are contained in a hash field.

Signal ingestion modules 101 can access “transdimensionality” transformations structured and defined in a “TLC” dimensional model. Signal ingestion modules 101 can apply the “transdimensionality” transformations to generic source data in raw signals to re-encode the source data into normalized data having lower dimensionality. Dimensionality reduction can include reducing dimensionality (e.g., hundreds, thousands, or even more signal features (dimensions)) of a raw signal into a normalized signal including a T vector, an L vector, and a C vector. At lower dimensionality, the complexity of measuring “distances” between dimensional vectors across different normalized signals is reduced.

Thus, in general, any received raw signals can be normalized into normalized signals including a Time (T) dimension, a Location (L) dimension, a Context (C) dimension, signal source, signal type, and content. Signal ingestion modules 101 can send normalized signals 122 to event detection infrastructure 103.

For example, signal ingestion modules 101 can send normalized signal 122A, including time 123A, location 124A, context 126A, content 127A, type 128A, and source 129A to event detection infrastructure 103. Similarly, signal ingestion modules 101 can send normalized signal 122B, including time 123B, location 124B, context 126B, content 127B, type 128B, and source 129B to event detection infrastructure 103.

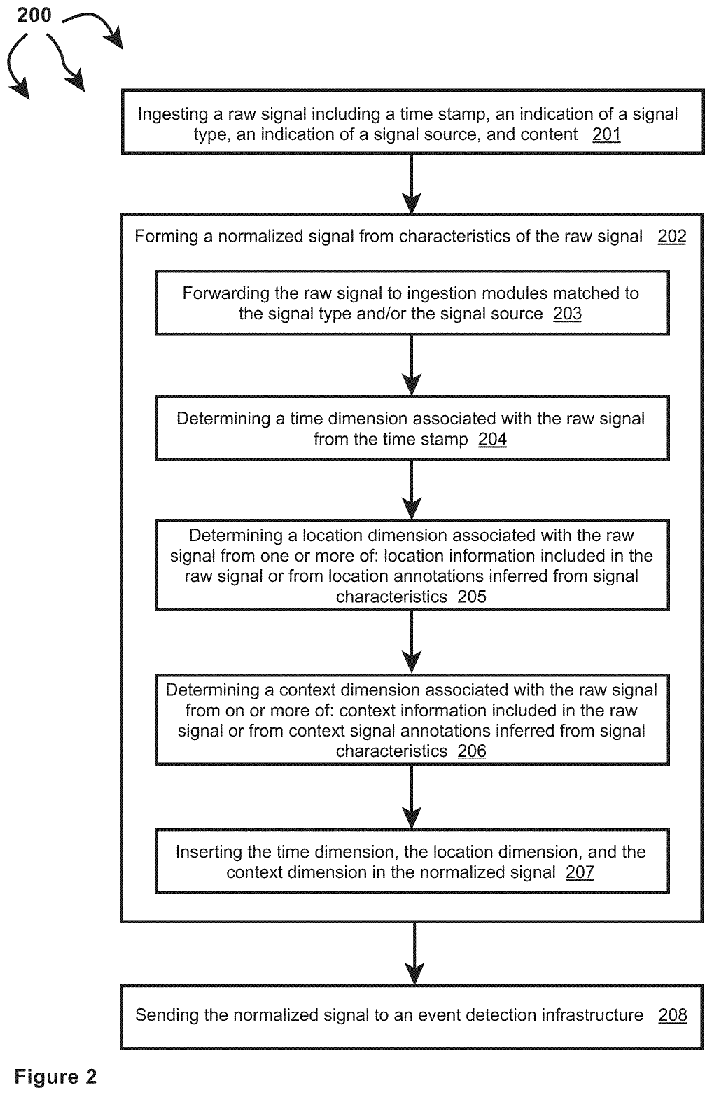

FIG. 2 illustrates a flow chart of an example method 200 for normalizing ingested signals. Method 200 will be described with respect to the components and data in computer architecture 100.

Method 200 includes ingesting a raw signal including a time stamp, an indication of a signal type, an indication of a signal source, and content (201). For example, signal ingestion modules 101 can ingest a raw signal 121 from one of: social signals 171, web signals 172, or streaming signals 173.

Method 200 incudes forming a normalized signal from characteristics of the raw signal (202). For example, signal ingestion modules 101 can form a normalized signal 122A from the ingested raw signal 121.

Forming a normalized signal includes forwarding the raw signal to ingestion modules matched to the signal type and/or the signal source (203). For example, if ingested raw signal 121 is from social signals 171, raw signal 121 can be forwarded to social content ingestion modules 174 and social signal processing modules 181. If ingested raw signal 121 is from web signals 172, raw signal 121 can be forwarded to web content ingestion modules 175 and web signal processing modules 182. If ingested raw signal 121 is from streaming signals 173, raw signal 121 can be forwarded to streaming content ingestion modules 176 and streaming signal processing modules 183.

Forming a normalized signal includes determining a time dimension associated with the raw signal from the time stamp (204). For example, signal ingestion modules 101 can determine time 123A from a time stamp in ingested raw signal 121.

Forming a normalized signal includes determining a location dimension associated with the raw signal from one or more of: location information included in the raw signal or from location annotations inferred from signal characteristics (205). For example, signal ingestion modules 101 can determine location 124A from location information included in raw signal 121 or from location annotations derived from characteristics of raw signal 121 (e.g., signal source, signal type, signal content).

Forming a normalized signal includes determining a context dimension associated with the raw signal from one or more of: context information included in the raw signal or from context signal annotations inferred from signal characteristics (206). For example, signal ingestion modules 101 can determine context 126A from context information included in raw signal 121 or from context annotations derived from characteristics of raw signal 121 (e.g., signal source, signal type, signal content).

Forming a normalized signal includes inserting the time dimension, the location dimension, and the context dimension in the normalized signal (207). For example, signal ingestion modules 101 can insert time 123A, location 124A, and context 126A in normalized signal 122. Method 200 includes sending the normalized signal to an event detection infrastructure (208). For example, signal ingestion modules 101 can send normalized signal 122A to event detection infrastructure 103.

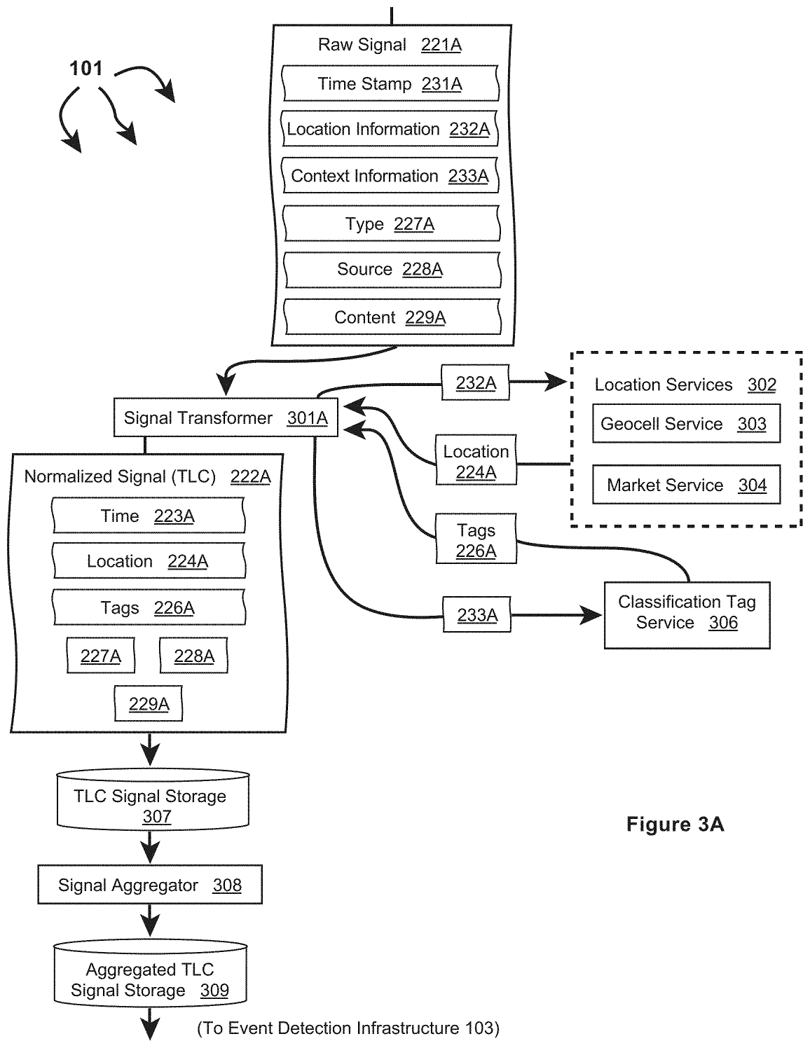

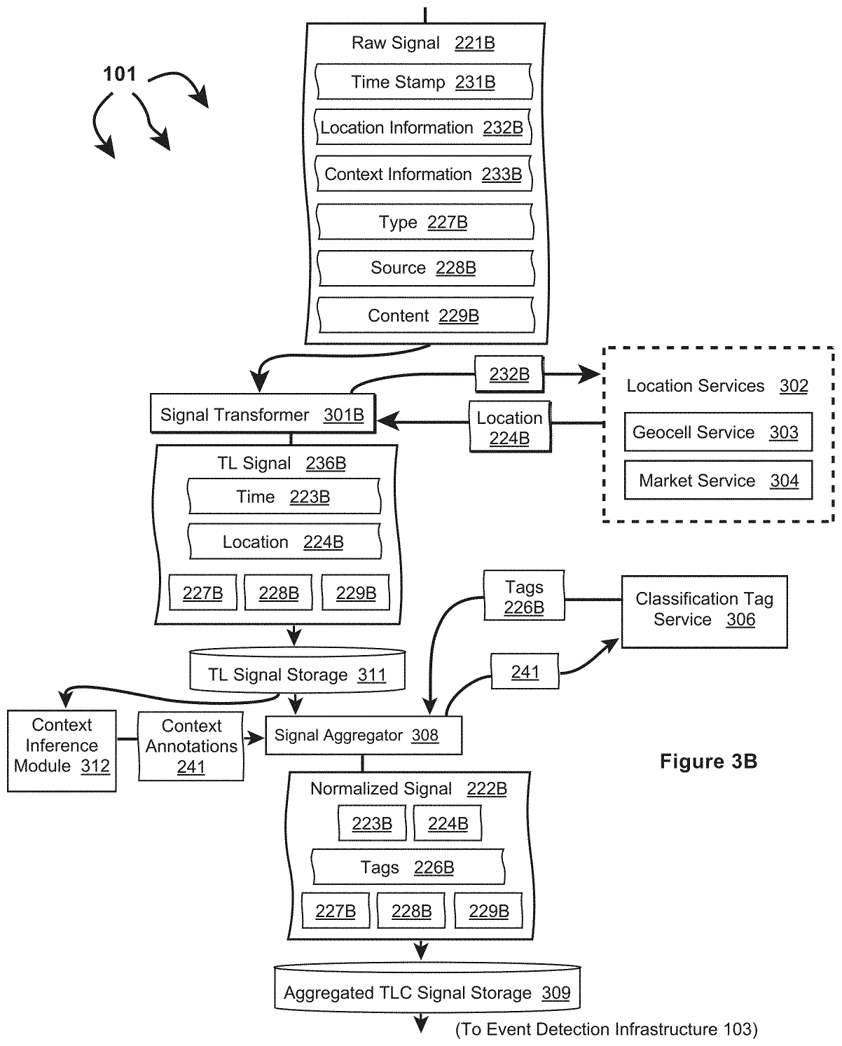

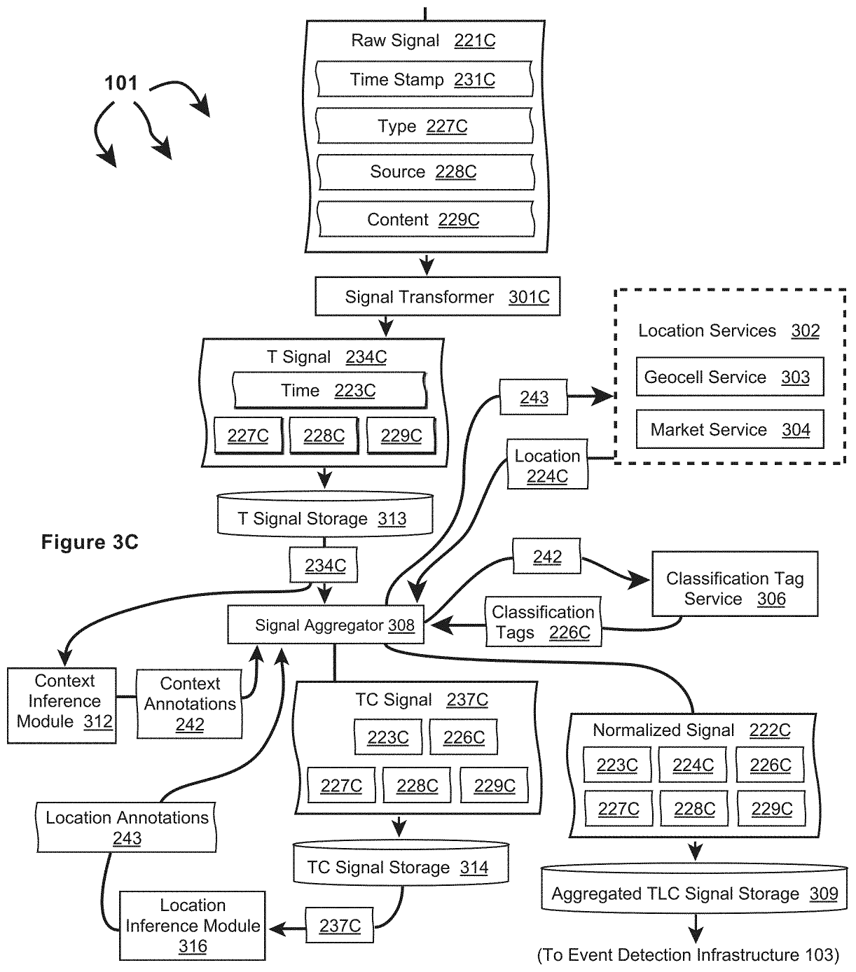

FIGS. 3A, 3B, and 3C depict other example components that can be included in signal ingestion modules 101. Signal ingestion modules 101 can include signal transformers for different types of signals including signal transformer 301A (for TLC signals), signal transformer 301B (for TL signals), and signal transformer 301C (for T signals). In one aspect, a single module combines the functionality of multiple different signal transformers.

Signal ingestion modules 101 can also include location services 302, classification tag service 306, signal aggregator 308, context inference module 312, and location inference module 316. Location services 302, classification tag service 306, signal aggregator 308, context inference module 312, and location inference module 316 or parts thereof can interoperate with and/or be integrated into any of ingestion modules 174, web content ingestion modules 176, stream content ingestion modules 176, social signal processing module 181, web signal processing module 182, and stream signal processing modules 183. Location services 302, classification tag service 306, signal aggregator 308, context inference module 312, and location inference module 316 can interoperate to implement “transdimensionality” transformations to reduce raw signal dimensionality into normalized TLC signals.

Signal ingestion modules 101 can also include storage for signals in different stages of normalization, including TLC signal storage 307, TL signal storage 311, T signal storage 313, TC signal storage 314, and aggregated TLC signal storage 309. In one aspect, data ingestion modules 101 implement a distributed messaging system. Each of signal storage 307, 309, 311, 313, and 314 can be implemented as a message container (e.g., a topic) associated with a type of message.

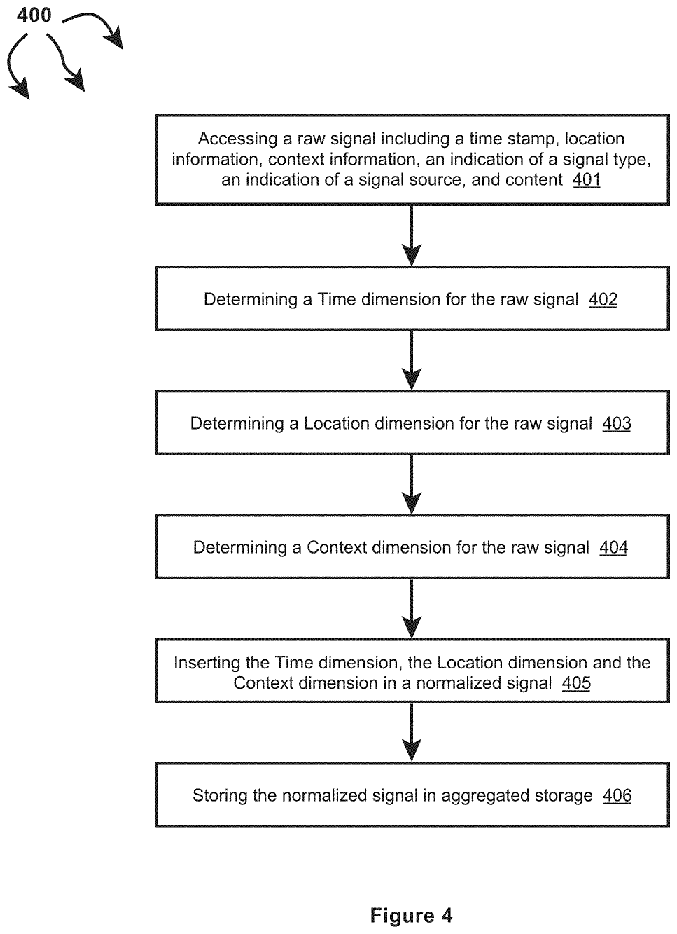

FIG. 4 illustrates a flow chart of an example method 400 for normalizing an ingested signal including time information, location information, and context information. Method 400 will be described with respect to the components and data in FIG. 3A.

Method 400 includes accessing a raw signal including a time stamp, location information, context information, an indication of a signal type, an indication of a signal source, and content (401). For example, signal transformer 301A can access raw signal 221A. Raw signal 221A includes timestamp 231A, location information 232A (e.g., lat/lon, GPS coordinates, etc.), context information 233A (e.g., text expressly indicating a type of event), signal type 227A (e.g., social media, 911 communication, traffic camera feed, etc.), signal source 228A (e.g., Facebook, twitter, Waze, etc.), and signal content 229A (e.g., one or more of: image, video, text, keyword, locale, etc.).

Method 400 includes determining a Time dimension for the raw signal (402). For example, signal transformer 301A can determine time 223A from timestamp 231A.

Method 400 includes determining a Location dimension for the raw signal (403). For example, signal transformer 301A sends location information 232A to location services 302. Geo cell service 303 can identify a geo cell corresponding to location information 232A. Market service 304 can identify a designated market area (DMA) corresponding to location information 232A. Location services 302 can include the identified geo cell and/or DMA in location 224A. Location services 302 return location 224A to signal transformer 301.

Method 400 includes determining a Context dimension for the raw signal (404). For example, signal transformer 301A sends context information 233A to classification tag service 306. Classification tag service 306 identifies one or more classification tags 226A (e.g., fire, police presence, accident, natural disaster, etc.) from context information 233A. Classification tag service 306 returns classification tags 226A to signal transformer 301A.

Method 400 includes inserting the Time dimension, the Location dimension, and the Context dimension in a normalized signal (405). For example, signal transformer 301A can insert time 223A, location 224A, and tags 226A in normalized signal 222A (a TLC signal). Method 400 includes storing the normalized signal in signal storage (406). For example, signal transformer 301A can store normalized signal 222A in TLC signal storage 307. (Although not depicted, timestamp 231A, location information 232A, and context information 233A can also be included (or remain) in normalized signal 222A).

Method 400 includes storing the normalized signal in aggregated storage (406). For example, signal aggregator 308 can aggregate normalized signal 222A along with other normalized signals determined to relate to the same event. In one aspect, signal aggregator 308 forms a sequence of signals related to the same event. Signal aggregator 308 stores the signal sequence, including normalized signal 222A, in aggregated TLC storage 309 and eventually forwards the signal sequence to event detection infrastructure 103.

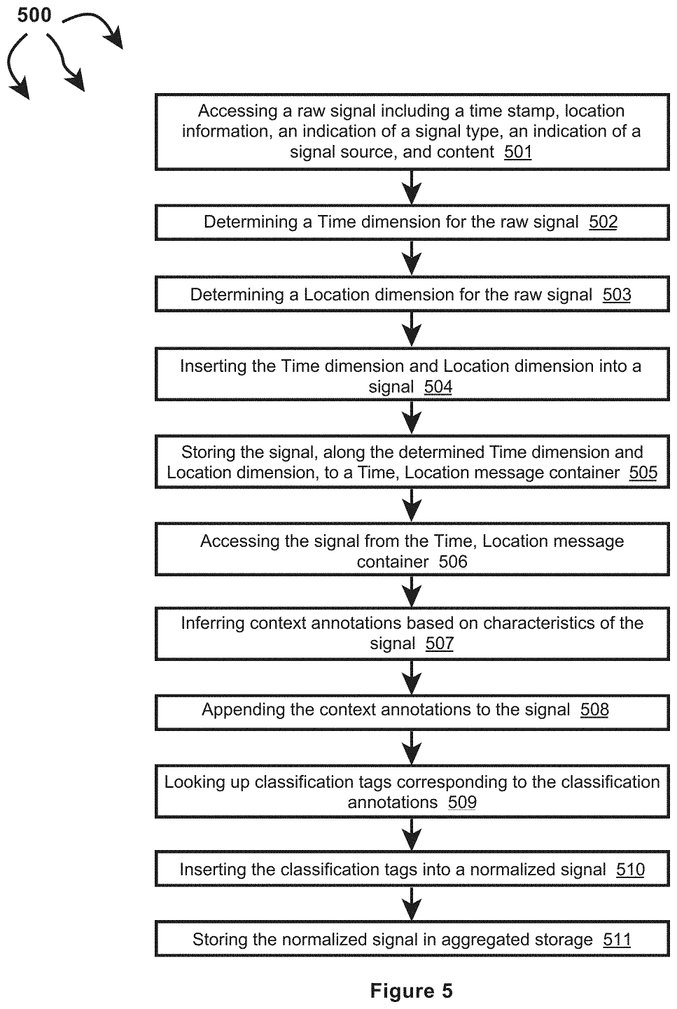

FIG. 5 illustrates a flow chart of an example method 500 for normalizing an ingested signal including time information and location information. Method 500 will be described with respect to the components and data in FIG. 3B.

Method 500 includes accessing a raw signal including a time stamp, location information, an indication of a signal type, an indication of a signal source, and content (501). For example, signal transformer 301B can access raw signal 221B. Raw signal 221B includes timestamp 231B, location information 232B (e.g., lat/lon, GPS coordinates, etc.), signal type 227B (e.g., social media, 911 communication, traffic camera feed, etc.), signal source 228B (e.g., Facebook, twitter, Waze, etc.), and signal content 229B (e.g., one or more of: image, video, audio, text, keyword, locale, etc.).

Method 500 includes determining a Time dimension for the raw signal (502). For example, signal transformer 301B can determine time 223B from timestamp 231B.

Method 500 includes determining a Location dimension for the raw signal (503). For example, signal transformer 301B sends location information 232B to location services 302. Geo cell service 303 can be identify a geo cell corresponding to location information 232B. Market service 304 can identify a designated market area (DMA) corresponding to location information 232B. Location services 302 can include the identified geo cell and/or DMA in location 224B. Location services 302 returns location 224B to signal transformer 301.

Method 500 includes inserting the Time dimension and Location dimension into a signal (504). For example, signal transformer 301B can insert time 223B and location 224B into TL signal 236B. (Although not depicted, timestamp 231B and location information 232B can also be included (or remain) in TL signal 236B). Method 500 includes storing the signal, along with the determined Time dimension and Location dimension, to a Time, Location message container (505). For example, signal transformer 301B can store TL signal 236B to TL signal storage 311. Method 500 includes accessing the signal from the Time, Location message container (506). For example, signal aggregator 308 can access TL signal 236B from TL signal storage 311.

Method 500 includes inferring context annotations based on characteristics of the signal (507). For example, context inference module 312 can access TL signal 236B from TL signal storage 311. Context inference module 312 can infer context annotations 241 from characteristics of TL signal 236B, including one or more of: time 223B, location 224B, type 227B, source 228B, and content 229B. In one aspect, context inference module 312 includes one or more of: NLP modules, audio analysis modules, image analysis modules, video analysis modules, etc. Context inference module 312 can process content 229B in view of time 223B, location 224B, type 227B, source 228B, to infer context annotations 241 (e.g., using machine learning, artificial intelligence, neural networks, machine classifiers, etc.). For example, if content 229B is an image that depicts flames and a fire engine, context inference module 312 can infer that content 229B is related to a fire. Context inference 312 module can return context annotations 241 to signal aggregator 308.

Method 500 includes appending the context annotations to the signal (508). For example, signal aggregator 308 can append context annotations 241 to TL signal 236B. Method 500 includes looking up classification tags corresponding to the classification annotations (509). For example, signal aggregator 308 can send context annotations 241 to classification tag service 306. Classification tag service 306 can identify one or more classification tags 226B (a Context dimension) (e.g., fire, police presence, accident, natural disaster, etc.) from context annotations 241. Classification tag service 306 returns classification tags 226B to signal aggregator 308.

Method 500 includes inserting the classification tags in a normalized signal (510). For example, signal aggregator 308 can insert tags 226B (a Context dimension) into normalized signal 222B (a TLC signal). Method 500 includes storing the normalized signal in aggregated storage (511). For example, signal aggregator 308 can aggregate normalized signal 222B along with other normalized signals determined to relate to the same event. In one aspect, signal aggregator 308 forms a sequence of signals related to the same event. Signal aggregator 308 stores the signal sequence, including normalized signal 222B, in aggregated TLC storage 309 and eventually forwards the signal sequence to event detection infrastructure 103. (Although not depicted, timestamp 231B, location information 232C, and context annotations 241 can also be included (or remain) in normalized signal 222B).

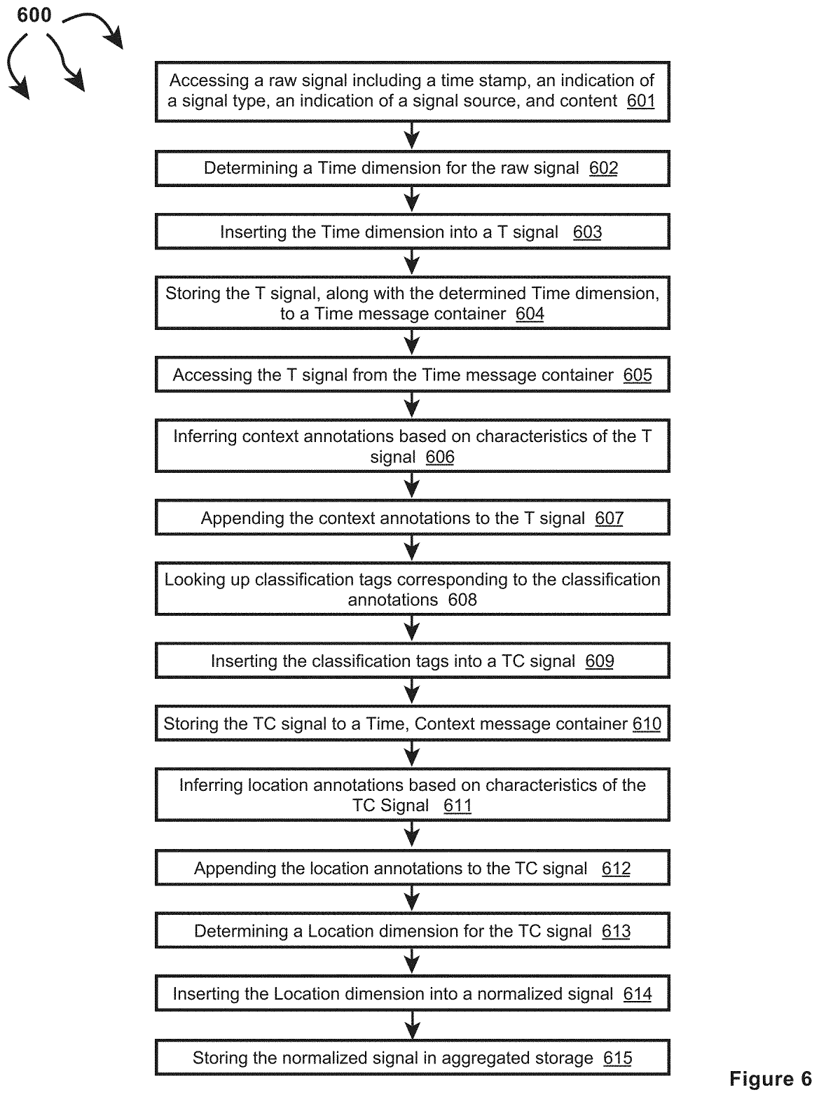

FIG. 6 illustrates a flow chart of an example method 600 for normalizing an ingested signal including time information and location information. Method 600 will be described with respect to the components and data in FIG. 3C.

Method 600 includes accessing a raw signal including a time stamp, an indication of a signal type, an indication of a signal source, and content (601). For example, signal transformer 301C can access raw signal 221C. Raw signal 221C includes timestamp 231C, signal type 227C (e.g., social media, 911 communication, traffic camera feed, etc.), signal source 228C (e.g., Facebook, twitter, Waze, etc.), and signal content 229C (e.g., one or more of: image, video, text, keyword, locale, etc.).

Method 600 includes determining a Time dimension for the raw signal (602). For example, signal transformer 301C can determine time 223C from timestamp 231C. Method 600 includes inserting the Time dimension into a T signal (603). For example, signal transformer 301C can insert time 223C into T signal 234C. (Although not depicted, timestamp 231C can also be included (or remain) in T signal 234C).

Method 600 includes storing the T signal, along with the determined Time dimension, to a Time message container (604). For example, signal transformer 301C can store T signal 236C to T signal storage 313. Method 600 includes accessing the T signal from the Time message container (605). For example, signal aggregator 308 can access T signal 234C from T signal storage 313.

Method 600 includes inferring context annotations based on characteristics of the T signal (606). For example, context inference module 312 can access T signal 234C from T signal storage 313. Context inference module 312 can infer context annotations 242 from characteristics of T signal 234C, including one or more of: time 223C, type 227C, source 228C, and content 229C. As described, context inference module 312 can include one or more of: NLP modules, audio analysis modules, image analysis modules, video analysis modules, etc. Context inference module 312 can process content 229C in view of time 223C, type 227C, source 228C, to infer context annotations 242 (e.g., using machine learning, artificial intelligence, neural networks, machine classifiers, etc.). For example, if content 229C is a video depicting two vehicles colliding on a roadway, context inference module 312 can infer that content 229C is related to an accident. Context inference 312 module can return context annotations 242 to signal aggregator 308.

Method 600 includes appending the context annotations to the T signal (607). For example, signal aggregator 308 can append context annotations 242 to T signal 234C. Method 600 includes looking up classification tags corresponding to the classification annotations (608). For example, signal aggregator 308 can send context annotations 242 to classification tag service 306. Classification tag service 306 can identify one or more classification tags 226C (a Context dimension) (e.g., fire, police presence, accident, natural disaster, etc.) from context annotations 242. Classification tag service 306 returns classification tags 226C to signal aggregator 308.

Method 600 includes inserting the classification tags into a TC signal (609). For example, signal aggregator 308 can insert tags 226C into TC signal 237C. Method 600 includes storing the TC signal to a Time, Context message container (610). For example, signal aggregator 308 can store TC signal 237C in TC signal storage 314. (Although not depicted, timestamp 231C and context annotations 242 can also be included (or remain) in normalized signal 237C).

Method 600 includes inferring location annotations based on characteristics of the TC signal (611). For example, location inference module 316 can access TC signal 237C from TC signal storage 314. Location inference module 316 can include one or more of: NLP modules, audio analysis modules, image analysis modules, video analysis modules, etc. Location inference module 316 can process content 229C in view of time 223C, type 227C, source 228C, and classification tags 226C (and possibly context annotations 242) to infer location annotations 243 (e.g., using machine learning, artificial intelligence, neural networks, machine classifiers, etc.). For example, if content 229C is a video depicting two vehicles colliding on a roadway, the video can include a nearby street sign, business name, etc. Location inference module 316 can infer a location from the street sign, business name, etc. Location inference module 316 can return location annotations 243 to signal aggregator 308.

Method 600 includes appending the location annotations to the TC signal with location annotations (612). For example, signal aggregator 308 can append location annotations 243 to TC signal 237C. Method 600 determining a Location dimension for the TC signal (613). For example, signal aggregator 308 can send location annotations 243 to location services 302. Geo cell service 303 can identify a geo cell corresponding to location annotations 243. Market service 304 can identify a designated market area (DMA) corresponding to location annotations 243. Location services 302 can include the identified geo cell and/or DMA in location 224C. Location services 302 returns location 224C to signal aggregation services 308.

Method 600 includes inserting the Location dimension into a normalized signal (614). For example, signal aggregator 308 can insert location 224C into normalized signal 222C. Method 600 includes storing the normalized signal in aggregated storage (615). For example, signal aggregator 308 can aggregate normalized signal 222C along with other normalized signals determined to relate to the same event. In one aspect, signal aggregator 308 forms a sequence of signals related to the same event. Signal aggregator 308 stores the signal sequence, including normalized signal 222C, in aggregated TLC storage 309 and eventually forwards the signal sequence to event detection infrastructure 103. (Although not depicted, timestamp 231B, context annotations 241, and location annotations 24, can also be included (or remain) in normalized signal 222B).

In another aspect, a Location dimension is determined prior to a Context dimension when a T signal is accessed. A Location dimension (e.g., geo cell and/or DMA) and/or location annotations are used when inferring context annotations.

Accordingly, location services 302 can identify a geo cell and/or DMA for a signal from location information in the signal and/or from inferred location annotations. Similarly, classification tag service 306 can identify classification tags for a signal from context information in the signal and/or from inferred context annotations.

Signal aggregator 308 can concurrently handle a plurality of signals in a plurality of different stages of normalization. For example, signal aggregator 308 can concurrently ingest and/or process a plurality T signals, a plurality of TL signals, a plurality of TC signals, and a plurality of TLC signals. Accordingly, aspects of the invention facilitate acquisition of live, ongoing forms of data into an event detection system with signal aggregator 308 acting as an “air traffic controller” of live data. Signals from multiple sources of data can be aggregated and normalized for a common purpose (e.g., of event detection). Data ingestion, event detection, and event notification can process data through multiple stages of logic with concurrency.

As such, a unified interface can handle incoming signals and content of any kind. The interface can handle live extraction of signals across dimensions of time, location, and context. In some aspects, heuristic processes are used to determine one or more dimensions. Acquired signals can include text and images as well as live-feed binaries, including live media in audio, speech, fast still frames, video streams, etc.

Signal normalization enables the world's live signals to be collected at scale and analyzed for detection and validation of live events happening globally. A data ingestion and event detection pipeline aggregates signals and combines detections of various strengths into truthful events. Thus, normalization increases event detection efficiency facilitating event detection closer to “live time” or at “moment zero”.

Event Detection

Turning back to FIG. 1B, computer architecture 100 also includes components that facilitate detecting events. As depicted, computer architecture 100 includes geo cell database 111 and event notification 116. Geo cell database 111 and event notification 116 can be connected to (or be part of) a network with signal ingestion modules 101 and event detection infrastructure 103. As such, geo cell database 111 and even notification 116 can create and exchange message related data over the network.

As described, in general, on an ongoing basis, concurrently with signal ingestion (and also essentially in real-time), event detection infrastructure 103 detects different categories of (planned and unplanned) events (e.g., fire, police response, mass shooting, traffic accident, natural disaster, storm, active shooter, concerts, protests, etc.) in different locations (e.g., anywhere across a geographic area, such as, the United States, a State, a defined area, an impacted area, an area defined by a geo cell, an address, etc.), at different times from Time, Location, and Context dimensions included in normalized signals. Since, normalized signals are normalized to include Time, Location, and Context dimensions, event detection infrastructure 103 can handle normalized signals in a more uniform manner increasing event detection efficiency and effectiveness.

Event detection infrastructure 103 can also determine an event truthfulness, event severity, and an associated geo cell. In one aspect, a Context dimension in a normalized signal increases the efficiency and effectiveness of determining truthfulness, severity, and an associated geo cell.

Generally, an event truthfulness indicates how likely a detected event is actually an event (vs. a hoax, fake, misinterpreted, etc.). Truthfulness can range from less likely to be true to more likely to be true. In one aspect, truthfulness is represented as a numerical value, such as, for example, from 1 (less truthful) to 10 (more truthful) or as percentage value in a percentage range, such as, for example, from 0% (less truthful) to 100% (more truthful). Other truthfulness representations are also possible. For example, truthfulness can be a dimension or represented by one or more vectors.

Generally, an event severity indicates how severe an event is (e.g., what degree of badness, what degree of damage, etc. is associated with the event). Severity can range from less severe (e.g., a single vehicle accident without injuries) to more severe (e.g., multi vehicle accident with multiple injuries and a possible fatality). As another example, a shooting event can also range from less severe (e.g., one victim without life threatening injuries) to more severe (e.g., multiple injuries and multiple fatalities). In one aspect, severity is represented as a numerical value, such as, for example, from 1 (less severe) to 5 (more severe). Other severity representations are also possible. For example, severity can be a dimension or represented by one or more vectors.

In general, event detection infrastructure 103 can include a geo determination module including modules for processing different kinds of content including location, time, context, text, images, audio, and video into search terms. The geo determination module can query a geo cell database with search terms formulated from normalized signal content. The geo cell database can return any geo cells having matching supplemental information. For example, if a search term includes a street name, a subset of one or more geo cells including the street name in supplemental information can be returned to the event detection infrastructure.

Event detection infrastructure 103 can use the subset of geo cells to determine a geo cell associated with an event location. Events associated with a geo cell can be stored back into an entry for the geo cell in the geo cell database. Thus, over time an historical progression of events within a geo cell can be accumulated.

As such, event detection infrastructure 103 can assign an event ID, an event time, an event location, an event category, an event description, an event truthfulness, and an event severity to each detected event. Detected events can be sent to relevant entities, including to mobile devices, to computer systems, to APIs, to data storage, etc.

Event detection infrastructure 103 detects events from information contained in normalized signals 122. Event detection infrastructure 103 can detect an event from a single normalized signal 122 or from multiple normalized signals 122. In one aspect, event detection infrastructure 103 detects an event based on information contained in one or more normalized signals 122. In another aspect, event detection infrastructure 103 detects a possible event based on information contained in one or more normalized signals 122. Event detection infrastructure 103 then validates the potential event as an event based on information contained in one or more other normalized signals 122.

As depicted, event detection infrastructure 103 includes geo determination module 104, categorization module 106, truthfulness determination module 107, and severity determination module 108.

Generally, geo determination module 104 can include NLP modules, image analysis modules, etc. for identifying location information from a normalized signal. Geo determination module 104 can formulate (e.g., location) search terms 141 by using NLP modules to process audio, using image analysis modules to process images and video frames, etc. Search terms can include street addresses, building names, landmark names, location names, school names, image fingerprints, etc. Event detection infrastructure 103 can use a URL or identifier to access cached content when appropriate.

Generally, categorization module 106 can categorize a detected event into one of a plurality of different categories (e.g., fire, police response, mass shooting, traffic accident, natural disaster, storm, active shooter, concerts, protests, etc.) based on the content of normalized signals used to detect and/or otherwise related to an event.

Generally, truthfulness determination module 107 can determine the truthfulness of a detected event based on one or more of: source, type, age, and content of normalized signals used to detect and/or otherwise related to the event. Some signal types may be inherently more reliable than other signal types. For example, video from a live traffic camera feed may be more reliable than text in a social media post. Some signal sources may be inherently more reliable than others. For example, a social media account of a government agency may be more reliable than a social media account of an individual. The reliability of a signal can decay over time.

Generally, severity determination module 108 can determine the severity of a detected event based on or more of: location, content (e.g., dispatch codes, keywords, etc.), and volume of normalized signals used to detect and/or otherwise related to an event. Events at some locations may be inherently more severe than events at other locations. For example, an event at a hospital is potentially more severe than the same event at an abandoned warehouse. Event category can also be considered when determining severity. For example, an event categorized as a “Shooting” may be inherently more severe than an event categorized as “Police Presence” since a shooting implies that someone has been injured.

Geo cell database 111 includes a plurality of geo cell entries. Each geo cell entry is included in a geo cell defining an area and corresponding supplemental information about things included in the defined area. The corresponding supplemental information can include latitude/longitude, street names in the area defined by and/or beyond the geo cell, businesses in the area defined by the geo cell, other Areas of Interest (AOIs) (e.g., event venues, such as, arenas, stadiums, theaters, concert halls, etc.) in the area defined by the geo cell, image fingerprints derived from images captured in the area defined by the geo cell, and prior events that have occurred in the area defined by the geo cell. For example, geo cell entry 151 includes geo cell 152, lat/lon 153, streets 154, businesses 155, AOIs 156, and prior events 157. Each event in prior events 157 can include a location (e.g., a street address), a time (event occurrence time), an event category, an event truthfulness, an event severity, and an event description. Similarly, geo cell entry 161 includes geo cell 162, lat/lon 163, streets 164, businesses 165, AOIs 166, and prior events 167. Each event in prior events 167 can include a location (e.g., a street address), a time (event occurrence time), an event category, an event truthfulness, an event severity, and an event description.

Other geo cell entries can include the same or different (more or less) supplemental information, for example, depending on infrastructure density in an area. For example, a geo cell entry for an urban area can contain more diverse supplemental information than a geo cell entry for an agricultural area (e.g., in an empty field).

Geo cell database 111 can store geo cell entries in a hierarchical arrangement based on geo cell precision. As such, geo cell information of more precise geo cells is included in the geo cell information for any less precise geo cells that include the more precise geo cell.

Geo determination module 104 can query geo cell database 111 with search terms 141. Geo cell database 111 can identify any geo cells having supplemental information that matches search terms 141. For example, if search terms 141 include a street address and a business name, geo cell database 111 can identify geo cells having the street name and business name in the area defined by the geo cell. Geo cell database 111 can return any identified geo cells to geo determination module 104 in geo cell subset 142.

Geo determination module can use geo cell subset 142 to determine the location of event 135 and/or a geo cell associated with event 135. As depicted, event 135 includes event ID 132, time 133, location 137, description 136, category 137, truthfulness 138, and severity 139.

Event detection infrastructure 103 can also determine that event 135 occurred in an area defined by geo cell 162 (e.g., a geohash having precision of level 7 or level 9). For example, event detection infrastructure 103 can determine that location 134 is in the area defined by geo cell 162. As such, event detection infrastructure 103 can store event 135 in events 167 (i.e., historical events that have occurred in the area defined by geo cell 162).

Event detection infrastructure 103 can also send event 135 to event notification module 116. Event notification module 116 can notify one or more entities about event 135.

Segmenting Video Stream Frames

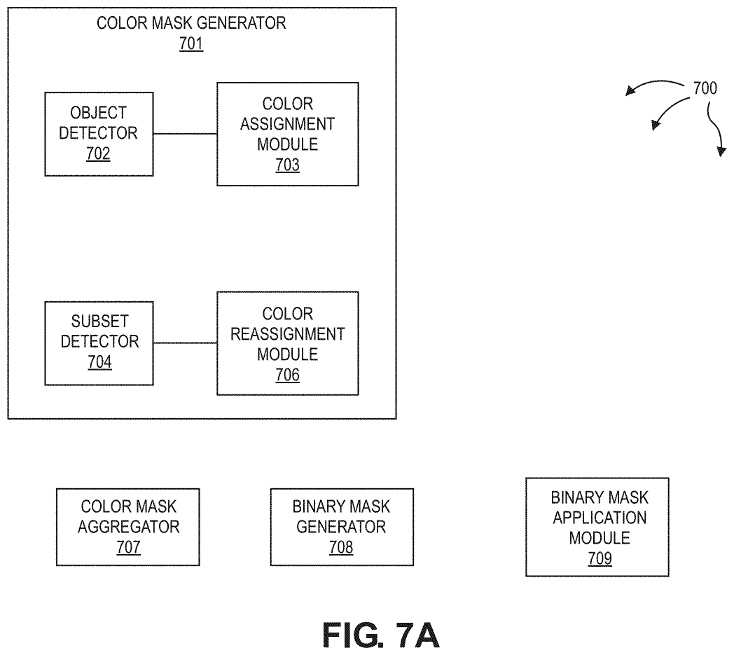

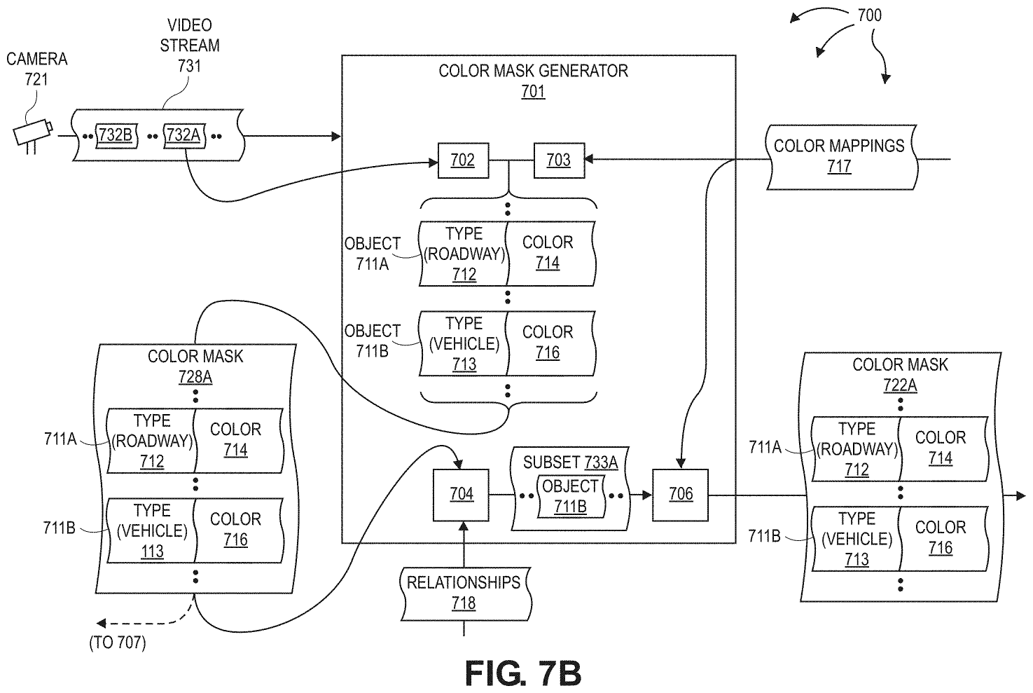

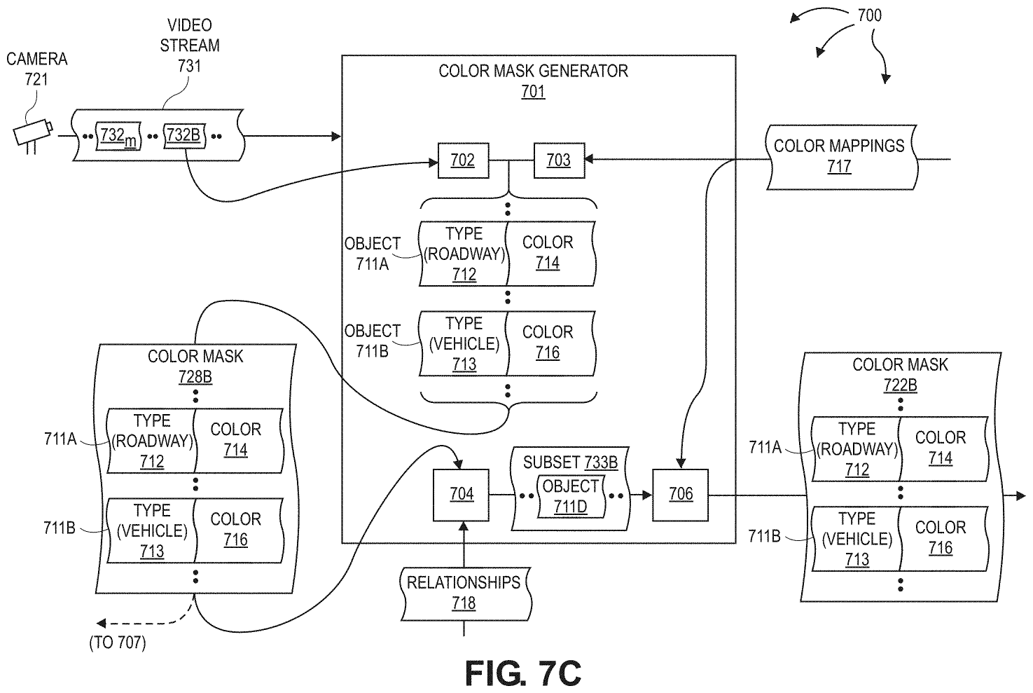

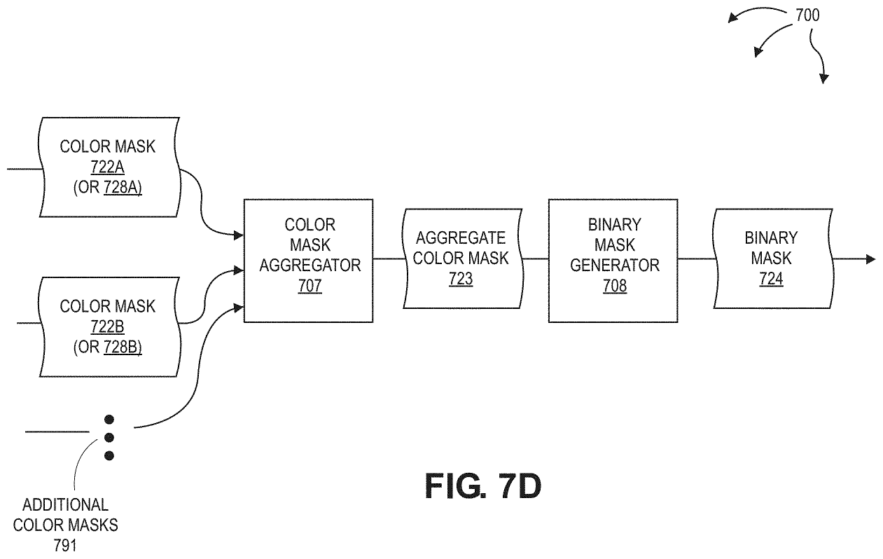

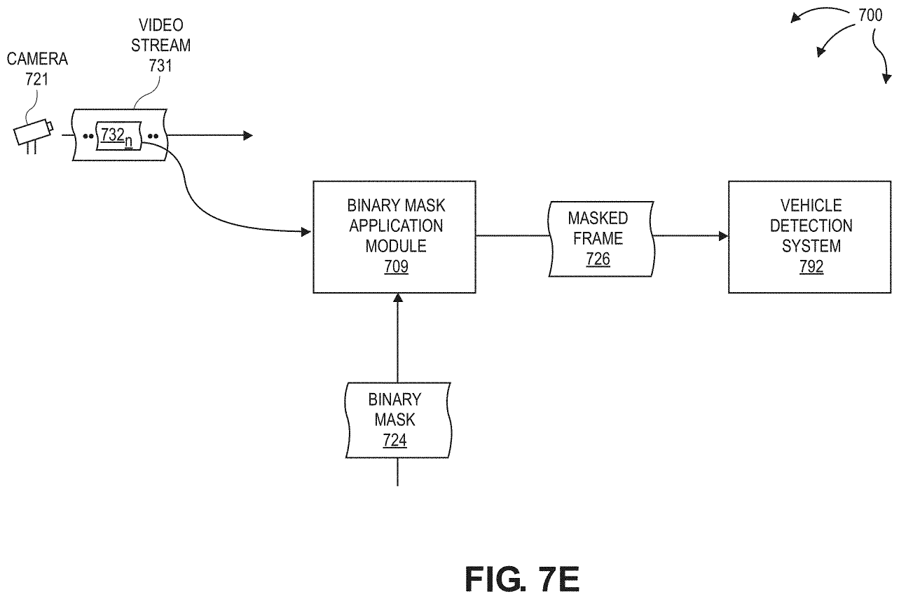

FIGS. 7A-7E depict a computer architecture 700 that facilitates segmenting video stream frames. As depicted, computer architecture 700 includes color mask generator 701, color mask aggregator 707, binary mask generator 708, and binary mask application module 709. Color mask generator 701 further includes object detector 702, color assignment module 703, subset detector 704, and color reassignment module 706.

In general, color mask generator 701 is configured to receive a video stream frame and generate a corresponding video stream frame color mask. Object detector 702 can detect object types in a video stream frame including but not limited to: roadway portions, vehicles, trees, bushes, guard rails, signs, walls, buildings, sky, etc. Each object type can be associated with a corresponding different defined color. Color assignment module 703 can assign defined colors to identified objects based on object type. For example, color assignment module 703 can assign one color to vehicles, a another color to roadway portions, a further color to the sky, etc.

Subset detector 704 can detect subsets of one object type that have a defined relationship with another object type. For example, subset detector 704 can detect one or more vehicles within a roadway portion. Color reassignment module 706 can reassign colors of an object type based on a defined relationship. For example, for any vehicles within a roadway, color reassignment module 706 can reassign a color assigned to vehicles to a color assigned to a roadway. That is, vehicles in a roadway can be assigned the same color as the roadway.

Color mask aggregator 707 can aggregate a plurality of video stream frame color masks into an aggregate (e.g., average) color mask. Binary mask generator can generate a binary mask for a video stream from an aggregate color mask. In one aspect, any pixels assigned the color of a particular object type (e.g., roadway portions) are assigned a “1” and pixels assigned colors of any other object type are assigned a “0” (absence of information).

Binary mask application module 709 can apply a binary mask to subsequent video stream frames to mask out objects other than the particular object type (e.g., that is more likely to be relevant during further processing). For example, a binary mask can be applied to a video stream frame to mask out objects other than roadways. Subsequent processing of the video stream frame can be limited to the particular object type. (e.g., to the roadway). As such, resources are not consumed processing parts of video stream frames unlikely to yield meaningful (e.g., relevant) results.

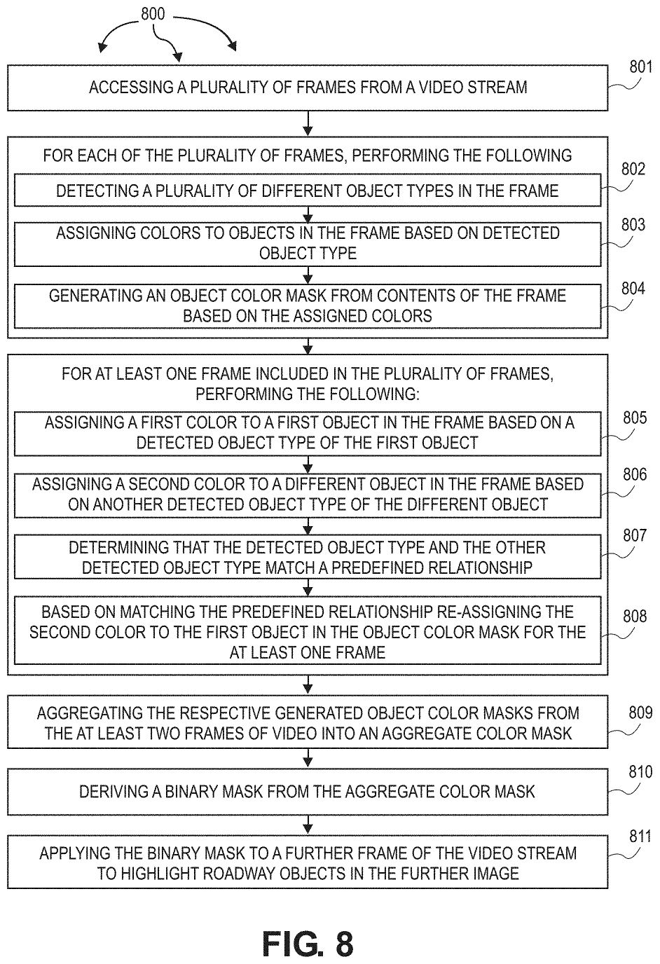

FIGS. 7B-7E more specifically depict using the modules of computer architecture 700 to segment video stream frames. FIG. 8 is a flow chart of an example method 800 for segmenting a video stream frame. Method 800 will be described with respect to the components and data in computer architecture 700.

Method 800 includes accessing a plurality of frames from a video stream (801). Camera 721 (e.g., a traffic camera or other public camera) can stream video stream 731. Color mask generator 701 can access frames 732A, 732B, . . . 732m, etc. from video stream 731.

Color mask generator 701 can process video stream 731 on a per frame basis. As such, for each of the plurality of frames, method 800 includes detecting a plurality of different object types in the frame (802). For example, in FIG. 7B, object detector 702 can detect objects 711A and 711B in frame 732A. Object detector 702 can determine that object 711A is of object type 712 (e.g., a roadway or roadway portion). Object detector 702 can determine that object 711B is of object type 713 (e.g., a vehicle, such as, a truck, a car, a bus, a van, a motorcycle, etc.)

For each of the plurality of frames, method 800 includes assigning colors to objects in the frame based on detected object type (803). Color assignment module 703 can refer to color mappings 717. Color mappings 717 can define mappings between object types and corresponding colors. For example, a roadway object type can be mapped to gray, a vehicle object type can be mapped to darker blue, a sky object type can be mapped to lighter blue, tree and bush object types can be mapped to green, etc. Accordingly, color assignment module 703 can assign color 714 (e.g., gray) to object 711A and can assign color 716 (e.g., darker blue) to object 711B.

For each of the plurality of frames, method 800 includes generating an object color mask from contents of the frame based on the assigned colors (804). For example, color mask generator 701 can generate color mask 728A (a color mask corresponding to video stream 731), including objects 711A, 712A, etc. In one aspect, color mask 728A is sent to color mask aggregator 707. In another aspect, color mask 728A is sent to subset detector 704.

Similarly, turning to FIG. 7C, object detector 702 can detect objects 711C and 711D in frame 732B. Object detector 702 can determine that object 711C is of object type 712 (e.g., a roadway or roadway portion). Object detector 702 can determine that object 711D is of object type 713 (e.g., a vehicle, such as, a truck, a car, a bus, a van, a motorcycle, etc.). Color assignment module 703 can assign color 714 (e.g., gray) to object 711C and can assign color 716 (e.g., darker blue) to object 711D. Color mask generator 701 can generate color mask 728B (a color mask corresponding to video stream 731), including objects 711C and 711D. In one aspect, color mask 728B is sent to color mask aggregator 707. In another aspect, color mask 728B is sent to subset detector 704.

For at least one frame included in the plurality of frames, method 800 includes assigning a first color to a first object in the frame based on a detected object type of the first object (805). For example, as described with respect to FIG. 7B, color assignment module 703 can assign color 714 to object 711A based on type 712. For the at least one frame included in the plurality of frames, method 800 includes assigning a second color to a different object in the frame based on another detected object type of the different object (806). Similarly, as described with respect to FIG. 7B, color assignment module 703 can assign color 716 to object 711B based on type 713.

Further, as described with respect to FIG. 7C, color assignment module 703 can assign color 714 to object 711C based on type 712. Similarly, as described with respect to FIG. 7C, color assignment module 703 can assign color 716 to object 711D based on type 713.

For the at least one frame included in the plurality of frames, method 800 includes determining that the detected object type and the other detected object type match a defined relationship (807). One or both of color mask 728A (corresponding to frame 732A) and color mask 728B (corresponding to frame 732B) can be sent to subset detector 704. Subset detector 704 can refer to object type relationships 718. Object type relationships 718 can define relationships between different object types. For example, object type relationships 718 can define relationship 718A between vehicles and roadways. Relationship 718A can define that vehicles detected within a roadway are to be considered (or re-typed for coloring, as opposed to object detection, as) part of the roadway. Relationships 718 can also define relationships between other combinations of described objects types, including between any of: roadway portions, vehicles, trees, bushes, guard rails, signs, walls, buildings, sky, etc.

As such, subset detector 704 can determine that object 711A (roadway) and object 711B (vehicle) match relationship 718A. For example, subset detector 104 can detect that object 711B (a vehicle object type) is within object 711A (a roadway portion object type). Thus, based on relationship 718A, subset detector 704 can determine that object 711B is to be assigned the color of object 711A. Subset detector 704 can alter a field value and/or attach an additional field to object 711B to indicate that color 716 is to be re-assigned to color 714. Subset detector 704 can include object 711B in subset 733A (a subset of objects that are to have colors re-assigned). Subset detector 704 can send subset 733A to color reassignment module 706.

In another aspect, subset detector 704 can determine that object 711C (roadway) and object 711D (vehicle) match relationship 718A. For example, subset detector 704 can detect that object 711D (a vehicle object type) is within object 711C (a roadway portion object type). Thus, subset detector 704 can determine that object 711D is to be assigned the color of object 711C. Subset detector 104 can alter a field value and/or attach an additional field to object 711D to indicate that color 716 is to be re-assigned to color 714. Subset detector 704 can include object 711D in subset 733B (a subset of objects that are to have colors re-assigned). Subset detector 704 can send subset 733B to color reassignment module 106.

For the at least one frame included in the plurality of frames, method 800 includes based on matching the predefined relationship, re-assigning the second color to the first object in the object color mask for the at least one frame (808). For example, in FIG. 7B, color reassignment module 706 receives subset 733A from subset detector 704. Referring to color mappings 717 color reassignment module 706 re-assigns colors to objects included in subset 733A. In one aspect, color reassignment module 706 accesses fields attached by subset detector 704. Color reassignment module 706 re-assigns colors to objects in accordance with the attached fields. For example, color reassignment module 706 can reassign color 714 to object 711B based on a field attached to object 711B by subset detector 704. Color mask generator 701 can output color mask 722B. As depicted, color mask 722A indicates that color 714 is assigned to both objects 711A and 711B.

In FIG. 7C, color reassignment module 706 receives subset 733B from subset detector 704. Referring to color mappings 717 color reassignment module 706 re-assigns colors to objects included in subset 733B. In one aspect, color reassignment module 706 accesses fields attached by subset detector 704. Color reassignment module 706 re-assigns colors to objects in accordance with the attached fields. For example, color reassignment module 706 can reassign color 714 to object 711D based on a field attached to object 711D by subset detector 704. Color mask generator 701 can output color mask 722B. As depicted, color mask 722B indicates that color 714 is assigned to both objects 711C and 711D.

Method 800 includes aggregating the respective generated object color masks from the at least two frames of video into an aggregate color mask (809). For example, turning to FIG. 7D, color mask aggregator 707 can aggregate color mask 722A (with color reassignments) (or 728A without color reassignments), color mask 722B (with color reassignments) (or 728B without color reassignments), and possibly additional color masks 791 (e.g., corresponding to additional frames of video stream 731) into aggregate color mask 723. Thus, one or more color masks including re-assigned colors can be aggregated with one another as well as with one or more other color masks. Color mask aggregator 707 can send aggregate color mask 723 to binary mask generator 708.

In one aspect, at least two color masks including objects with reassigned colors (e.g., color mask 722A and color mask 722B) (and potentially along with one or more other color masks, which may or may not include objects with reassigned colors) are aggregated into an aggregate color mask. In another aspect, one color mask including objects with reassigned colors (e.g., color mask 722A) is aggregated along with one or more other color masks (e.g., color mask 728B) (which may or may not have reassigned colors) into an aggregate color mask.

In one aspect, aggregating color masks includes averaging colors across color masks. Thus, when color masks corresponding to a sufficient number of frames are combined, roadway portion objects as well as other objects can be more efficiently distinguished.

Method 800 includes deriving a binary mask from the aggregate color mask (810). For example, binary mask generator 708 can generate binary mask 724 from aggregate color mask 723. Binary mask 724 can include a “1” or “0” per pixel of aggregate color mask 723. Generating binary mask 724 can include assigning a “1” to pixels assigned a specific color and assigning a “0” to pixels assigned all other colors. In one aspect, portions of aggregate color mask 723 assigned gray color (and, for example, thus corresponding to roadway portions) are assigned “1” and all other portions of aggregate color mask 723 are assigned “0”. Binary mask generator 708 can make binary mask 724 available to binary mask application module 709. In one aspect, binary mask 724 is stored in durable storage.

In FIGS. 7B and 7C, vehicles in a roadway are reassigned to a color defined for the roadway (e.g., gray). As such, the roadway can be more uniformly masked. That is, vehicles in the roadway cause little, if any, interruption in masking the roadway relative to other objects in frames 732A, 732B, etc.

Method 800 includes applying the binary mask to a further frame of the video stream to highlight roadway objects in the further image (811). For example, turning to FIG. 7E, binary masked application module 709 can access additional frames from video stream 731, such as, frames 732m through 732n (e.g., 732n can be received sometime after frame 732m). Binary mask application module 709 can also access binary mask 724 (e.g., from durable storage). Binary mask application module 709 can apply binary mask 724 to a frame 732 (e.g., 732n) to derive masked frame 726. Pixels of the frame (e.g., 732n) corresponding “1” in binary mask 724 can be depicted in masked frame 726. On the other hand, pixels of frame 732 corresponding “0” in binary mask 724 can be obscured (e.g., blacked out) in masked frame 726. Masked frame 726 can be sent to vehicle detector systems 792 (which may be included in an event detection infrastructure, such as, event detection infrastructure 103 in FIG. 1B).

In one aspect, all objects in a frame except those colored as roadway are obscured.

Although vehicles can be recolored for purposes of masking, vehicles can be considered based on initial coloring for purposes of vehicle detection. Vehicle detection systems 792 can receive masked frame 726 from binary mask application module 709. Vehicle detection systems 792 may ignore masked out portions of masked frame 726 when attempting to detect vehicles in frame 732n. Thus, less than all of the frame (e.g., 732n) is processed, conserving resources relative to processing an entire frame.

Thus, during binary mask derivation for a video stream, when an object of one object type is detected within another object of another object type the color assigned to the other object type is also assigned to the object type. For example, when a vehicle object is detected within a roadway object, the color assigned to the roadway object can also be assigned to the vehicle object. As such, a derived binary mask can better approximate the area of the other object type within one or more frames. For example, when deriving a binary mask for frames that include a roadway, vehicles on the roadway are considered part of the roadway. Thus, a derived binary mask better approximates the area of the roadway within the frames. For example, there are no “holes” in the binary mask due to vehicles detected in a roadway being assigned a different color than the roadway.

When the binary mask is applied to subsequent frames of the video stream, the area of the other object type can be more appropriately represented. Detecting objects of the object type can be focused on areas highlighted by the binary mask (e.g., areas assigned a binary ‘1’). For example, an area of a roadway can be more appropriately represented, and vehicle detection focused on the roadway. Focusing detection on portions of a frame highlighted by a binary mask conserves resources relative to processing an entire frame. For example, a binary mask can be applied to frames of a roadway environment to focus vehicle detection on a roadway and away from other portions of frames that are unlikely to include vehicles (e.g., the sky, bushes, trees, buildings, etc.).

An inverse binary mask can be used to present everything in a frame except objects assigned to specified color, for example, roads. An inverse binary mask can be used a reference frame to understand a camera's PTZ value. As such, if a camera configuration is altered, for example, zooms in, zooms out, rotates, changes angle, etc., the background would change, and fames may provide unusual detection values (relative to values prior to the configuration change). When camera configuration changes, the current background in the frame can be compared to the reference background image created by the inverse mask to identify a PTZ change. A PTZ change can trigger calibration modules to calibrate a camera accordingly.

In another aspect, color mask aggregator 707 includes the functionality of subset detector 704 and color reassignment module 706. Color mask aggregator 707 can identify subsets of objects in an aggregate color mask. Color mask aggregator 707 can refer to color mappings 717 to re-assign colors to objects. Reassigning colors in an aggregate color mask reduces the number of times color reassignment is performed. Further, aggregated color masks may include overlapping colors from multiple frames. When overlapping colors are re-assigned once, resources are conserved (relative to re-assigned colors per color mask).

The components in computer architecture 700 can be connected to (or be part of) a network, such as, for example, a system bus, a Local Area Network (“LAN”), a Wide Area Network (“WAN”), and even the Internet, along with components of computer architecture 100. Accordingly, the components as well as any other connected computer systems and their components can create and exchange data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network. As such, components in computer architectures 700 can interoperate with (or even be included in) components in computer architecture 100 to implement aspects of the invention.

Video Profiling/Calibration System

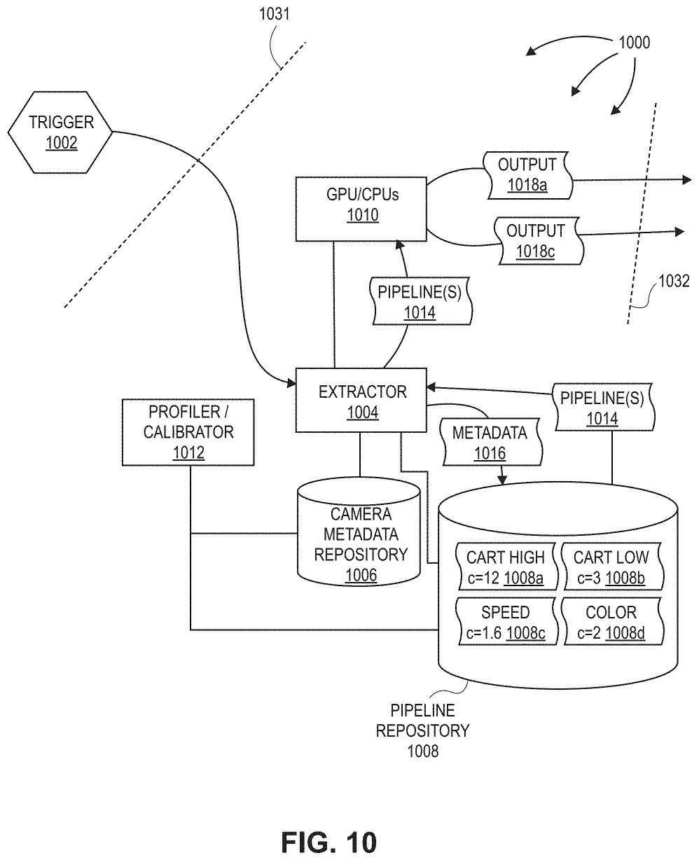

FIG. 10 illustrates a computer architecture 1000 that facilitates video device profiling/calibration. Upon receiving an external trigger 1002, an extractor 1004 facilitates profiling a video device. As depicted, extractor 1004 is connected to camera metadata repository 1006, pipeline repository 1008, and one or more video processing GPUs and/or CPUs 1010. Profiler 1012 can also be connected to camera metadata repository 1006 and/or pipeline repository 1008.

As depicted, extractor 1004 may utilize metadata 1016 to query within pipeline repository 1008 to select one or more pipelines 1014. For example, based on a trigger (e.g., trigger 1002) and data obtained from camera metadata repository 1006, extractor 1004 can determine one or more pipelines 1014 that satisfy requirements of the trigger. Extractor 1004 may then cause pipelines 1014 to be executed or run using video processing hardware (e.g., one or more of: GPUs, CPUs, TPUs, etc.) 1010. The hardware may then produce output for the one or more pipelines, for example, output 1018a (corresponding to pipeline 1008a for a “Child Abduction Response Team (CART) High,” output corresponding to pipeline 1008b for “CART Low,” output 1018C (corresponding to pipeline 1008c for a “Speed” pipeline), or output corresponding to pipeline 1008d for a “Color” pipeline.

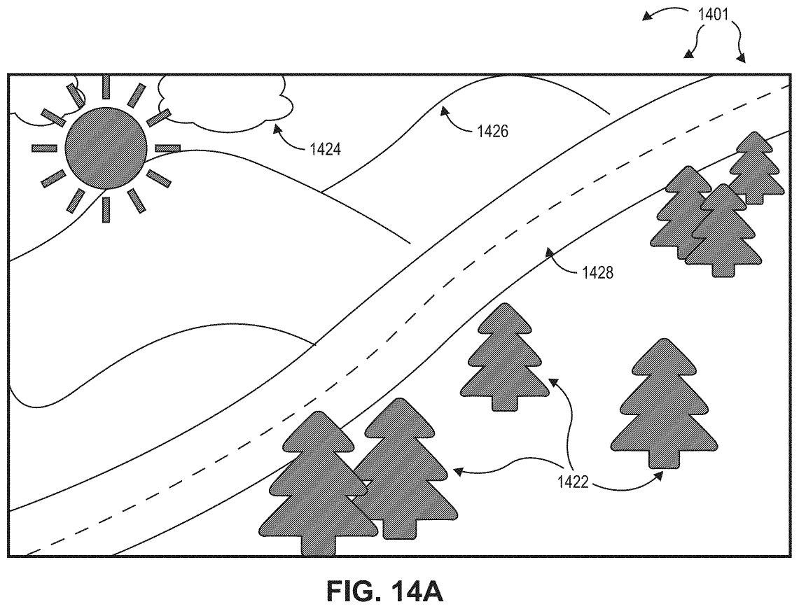

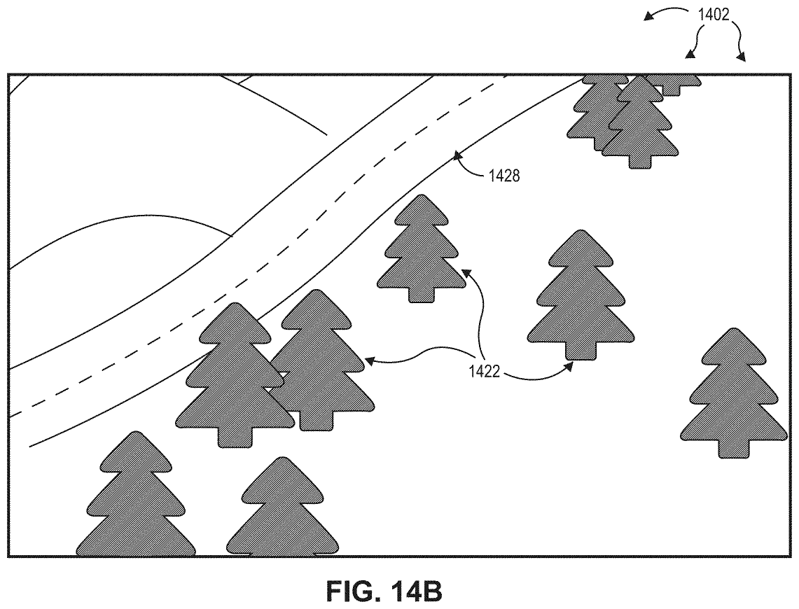

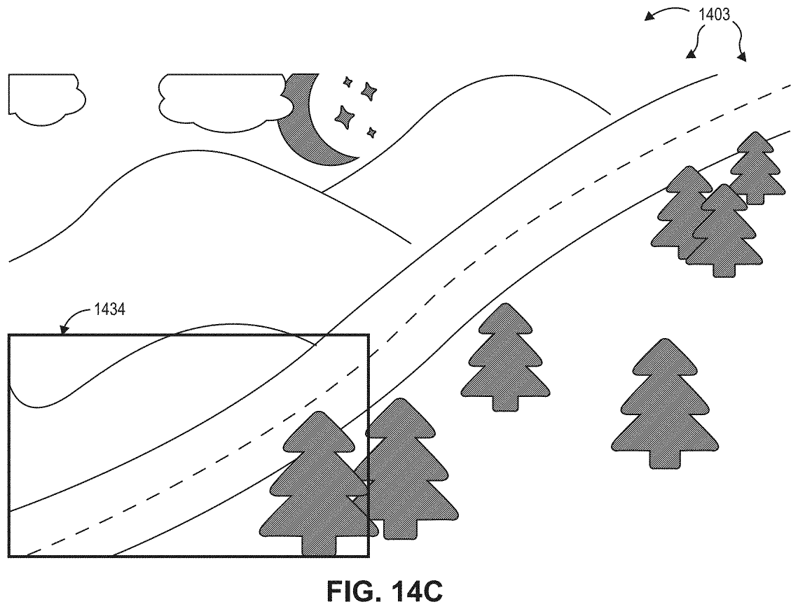

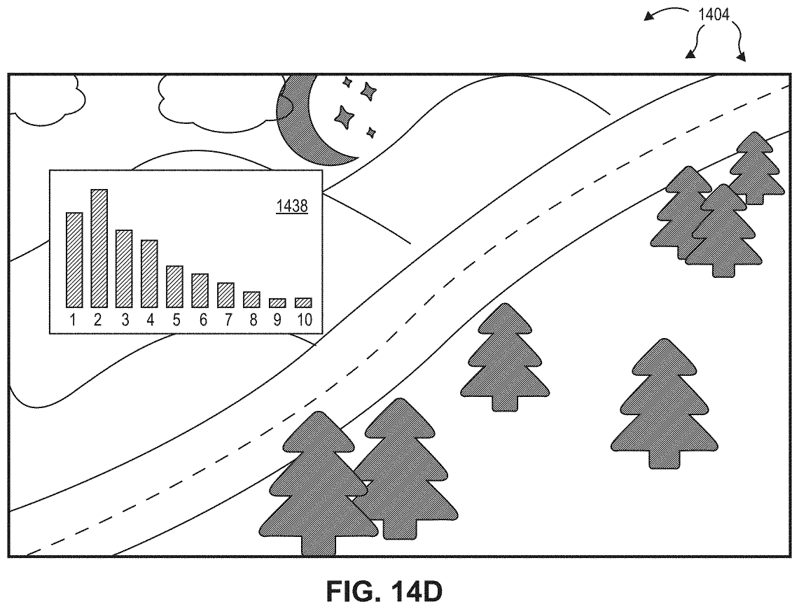

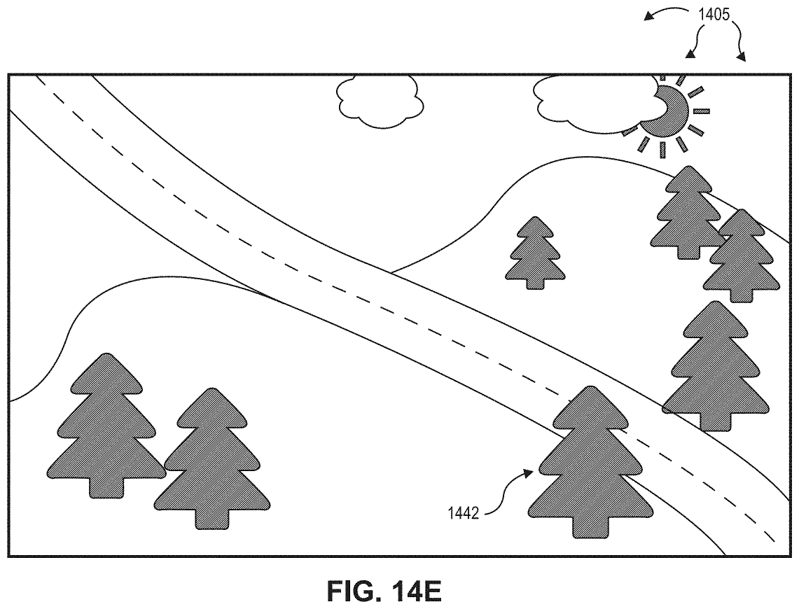

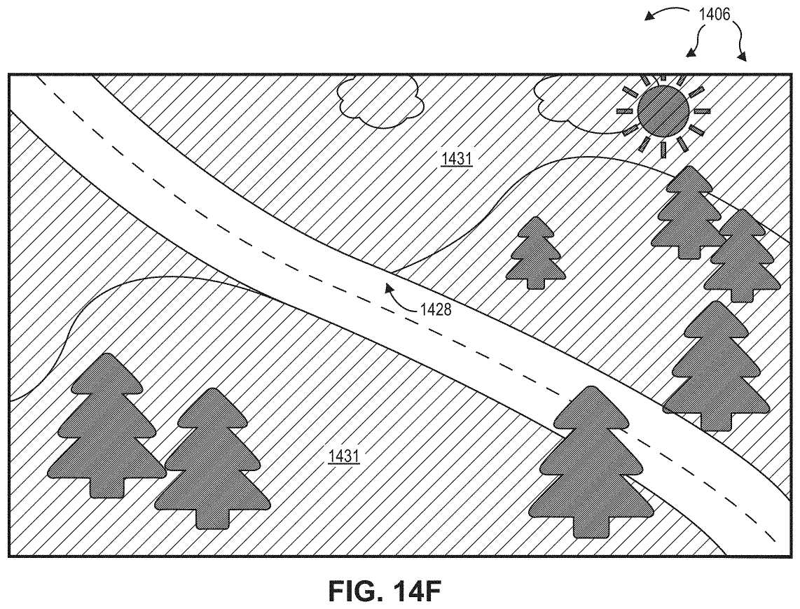

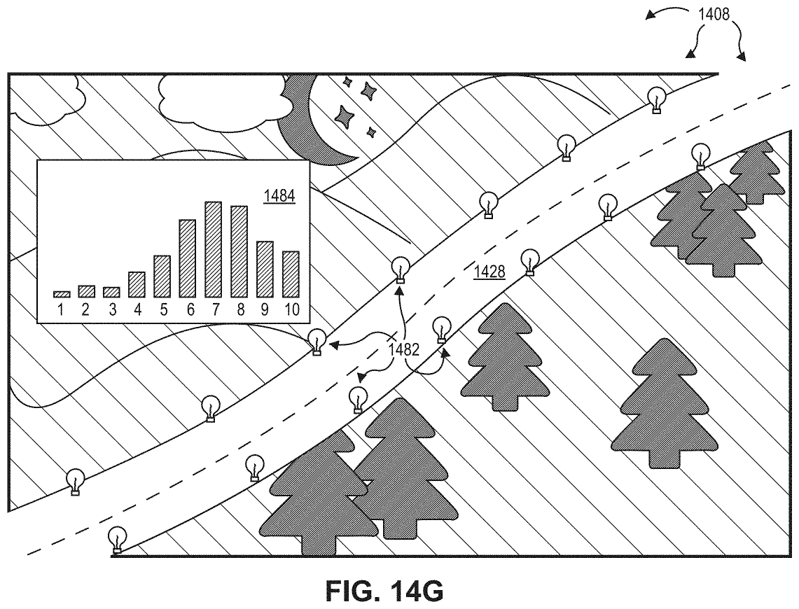

Dashed line 1031 represents a boundary separating a video profiling/calibration portion of computer architecture 1000 from other systems. Thus, trigger 1002 can originate in a separate system, such as event detection infrastructure 103. In other aspects, trigger 1002 occurs at a profiling and/or calibration interval (one example of which is described with respect to computer architecture 1400 in FIG. 14).

Dashed line 1032 also represents a boundary separating a video profiling/calibration portion of computer architecture 1000 from other systems (and which may or may not differ from other systems on the other side of boundary 1031). In one aspect, outputs 1018a, 1018c, etc. are provided to event detection infrastructure 103.

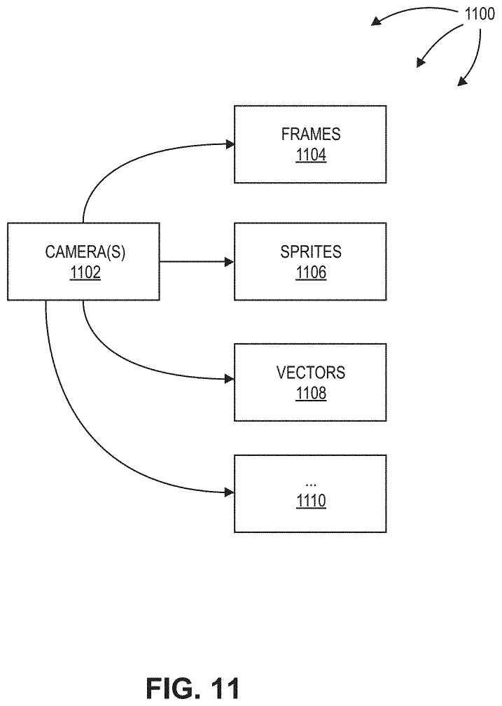

FIG. 11 illustrates an example camera system 1100. Camera system 1100 can include camera(s) 1102. In one aspect, camera(s) 1102 is/are any image capture device that produces frame-based image output. For example, each of camera(s) 1102 may be configured to produce images at a set framerate interval to capture images (frames) within a field of view over time. Images (frames) may then be combined together to produce framesets that, when played in sequence, produce a video stream representing the field of view over a timeframe.

To improve storage and playback efficiencies of large frame sets, any of a number of known processes can be applied to a frameset to reduce frameset size. For example, rather than storing every single frame precisely as captured, compression algorithms can be used to reduce the size of each frame. The compressed video streams can then be stored and/or utilized by other systems more easily.

In the case of profiling/calibrating, compressed video streams may not fully and/or accurately represent the state of a video capture device (a camera). For example, a video device quality determination may be under-valued if a compressed video output is used as a representative sample of output from the video device. As such, it may be desirable to store sample original (e.g., uncompressed and/or raw) video device frame sets for a video device that serve as a more representative sample of the actual output capability of the video device.

Frames/framesets 404 can be, for example, compressed or uncompressed frames and/or framesets stored as video files. Frames/framesets 404 can be stored in a repository.

Master sprites 1106 represent an example of original (uncompressed/raw) video device framesets. Master sprites 1106 may be stored as referential framesets in a repository dedicated to storing the raw frames from one or more video devices. Master sprites 1106 may be of a consistent length (e.g., 30 seconds of frames, 1000 frames, 50 megabytes, etc.). In other aspects, the quantity of master sprites 406 for a given video device may be determined based on other characteristics of the given video devices such as base resolution, deploying entity, location, etc.

Camera(s) 1102 can also produce vectors 1108. Vectors 1108 can represent data used to determine (e.g., certain types) frame output characteristics of/from video devices. For example, vectors 1108 may include motion vectors that represent a degree of movement from one frame to a subsequent frame. Thus, vectors 1108 can be used to determine different types of movement. In one aspect, vectors 1108 may be utilized to determine the amount of camera movement that has occurred between two frames.

For example, one frame can be compared to a subsequent frame. Within the two frames, a static object (e.g., an object that has not moved) is identified in each frame. Camera(s) 1102 (or other computing devices) can perform analysis to identify whether the static object is in a different location in the subsequent frame than the original frame. In one aspect, hardware 1010 (e.g., GPUs, CPUs, TPUS, etc.) are included in camera(s) 1102. If it is, the degree of camera movement between the two frames can be determined (e.g., a pixel shift distance for the object within the frame). Vector calculation can be useful in determining certain environmental or other external effect characteristics of a camera, such as whether the camera is shaking, vibrating, or swaying. Vector(s) 1108 can be stored in conjunction with camera(s) 1102 and used to determine overall quality of video device output.

Ellipsis 1110 indicates that camera 1102 may output additional information that is useful in or used during profiling, such as, metadata within a frame sequence or other information.

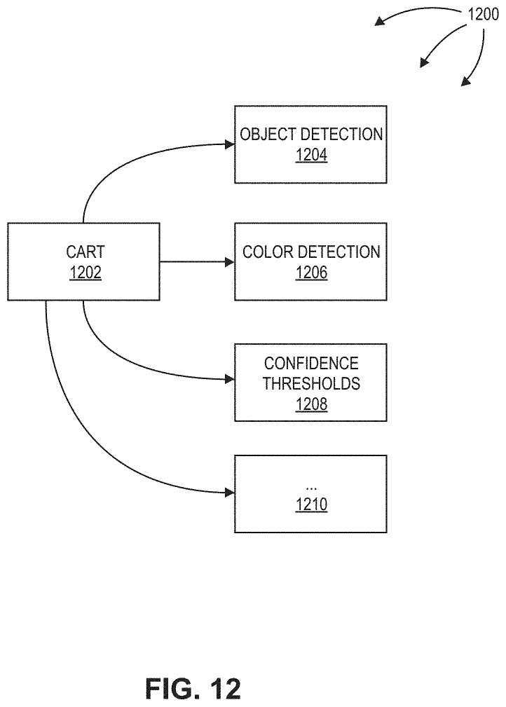

FIG. 12 illustrates an example processing pipeline architecture 1200. Processing pipeline architecture 1200 can include one or more of: data operations, data analysis, data transformations, data algorithms, etc. Processing pipeline architecture 1200 can receive video or other input stream types (e.g., audio, metadata, etc.) and process those input streams to perform detections.

As depicted, processing pipeline architecture 1200 includes CART pipeline 1202. CART pipeline 1202 further includes object detection 1204, color detection 1206, and confidence thresholds 1208. Ellipsis 1210 indicates that CART pipeline 1202 may include additional components, outputs, etc.

Object detection 1204 may comprise one or more operations or calculations that are used to identify objects within a video stream, such as the output from camera(s) 1102. In order to accomplish object detection 1204, CART pipeline 1202 can utilize various characteristics from an underlying data stream. For example, object detection 1204 can use a video stream that has a minimum frame rate, a minimum resolution, a minimum stability value, and/or specific scene characteristics.

Likewise, color detection 1206 can utilize various characteristics of a data stream to produce detections from the data stream. For example, color detection 1206 can utilize a video stream that includes colorized frames (e.g., instead of black and white frame or infrared enhanced frames).

As described, actual characteristics of a video device and corresponding output may not be directly available to a monitoring entity and/or pipeline executing entity. However, the actual characteristics can be derived from video frame analysis. Further, output from a video device operating in the real world may not be consistent over time. For example, a video device may be capable of providing a data stream sufficient for CART pipeline 1202 during one period of the day but may not be capable of doing so at a different time of day (e.g., daytime vs. nighttime).

Additionally, capabilities of a video device may degrade over time due to factors such as accumulation of hard water deposits on a lens or sensor degradation caused by continued UV light exposure. Thus, a camera that was previously capable of providing data sufficient for a particular pipeline may no longer be able to do so. In other scenarios, a video device may be capable of providing sufficient output when it is oriented in one direction (e.g., with the sun out of the frame) but be incapable of sufficient output while in a different orientation (e.g., with the sun in frame). As such, it may be impossible to determine based solely on initial characteristics of a video device whether that device can presently/currently provide output sufficient for a desired pipeline to operate.

Confidence Values

Confidence values (or scores) can be computed and used to predict whether video device output is sufficient for submission to a particular pipeline. For example, a computer system can subject a video device to a profiling process. As part of the profiling process, the computer system can compute a corresponding confidence score or value in each of a plurality of output categories.

Each pipeline can also be associated with a rule set defining minimum or sufficient confidence thresholds in order to use the pipeline. In some aspects, a confidence threshold associated with a pipeline is a hard threshold. When a confidence value (or score) corresponding to a video device satisfies confidence thresholds for a pipeline, video streams from the video device can be submitted to the pipeline. On the other hand, when a confidence value (or score) corresponding to a video device does not satisfy confidence thresholds for a pipeline, video streams from the video device are prevented from being submitted to the pipeline.

In other aspects, a confidence threshold associated with a pipeline is considered a recommendation. When a confidence value (or score) corresponding to a video device does not satisfy confidence thresholds for a pipeline, video streams from the video device can still be submitted to the pipeline. Pipeline output can be appended with an indication that the video device confidence score did not satisfy the confidence threshold associated with the pipeline. Utilizing confidence thresholds as recommendations allows other systems to consider output from video devices having non-satisfactory confidence scores as secondary data within the pipeline or for some other use.

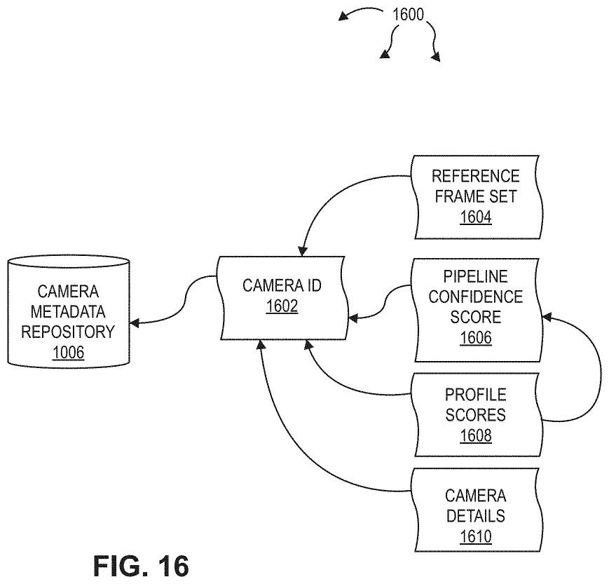

As depicted, a computer system can assign confidence thresholds 1208 to CART pipeline 1202. Generally (and described in further detail with respect to computer system FIG. 16), confidence thresholds 1208 can be evaluated against confidence values for incoming streams. A broader system (e.g., system 1000) can make a go/no-go determination regarding whether to operate the complete pipeline 1202 using the input data stream. CART pipeline 1202 can also include other components or processes as depicted by element 1210.

Profiling

To determine whether a particular video device's output is appropriate as input to a particular pipeline, the output of the video device can be profiled and compared to requirements of the pipeline.

Video device profiling may include determining both inherent characteristics (or properties) as well as user-configurable characteristics (or properties) of a video device. Inherent video device characteristics can include characteristics that are selected during manufacture of a video device and may be associated with hardware included the video devices. Inherent video device characteristics can include sensor resolution, sensor type, lens aperture, color profile, field of view, or other physical video device characteristics. Inherent video device characteristics may more difficult to change, for example, requiring modification of hardware components. However, inherent characteristics of a video device can change (e.g., degrade) over time due to use, operating environment conditions (including various weather conditions, such as, sun, rain, wind, temperature, etc.), etc.

For example, a lens may become clouded over time affecting (degrading) the quality of light that reaches the sensor. In another example, sensor pixels may become damaged overtime resulting in artifacts in the output of the video device. In another example, a field of view modifier (e.g., autofocus hardware) may malfunction or fail resulting in an inability to change the FOV of the camera device. UV rays can also degrade video device sensors.

As such, changes to inherent video device characteristic can cause corresponding changes to video device output. Aspects of the invention include profiling video devices on an ongoing basis to account for changes to, including degradation of, inherent video device characteristics. Accordingly, profiling video devices on an ongoing basis helps ensure that video device output is utilized with appropriate pipelines.

In addition to inherent characteristics, a video device can also include other characteristics designed for efficient and effective user configuration (i.e., user-configurable characteristics). For example, a video device may be configured to operate at one of several different frame capture rates, for example, 5 fps, 10 fps, 15 fps, 30 fps, 60 fps, or 120 fps (other video devices may have other frame capture rate options). Through a user interface a user can change between the different frame capture rates. Based at least in part on a specific environment and purpose, video device frame rates may be set to less than 5 fps (e.g., a video device providing extended time-lapse imagery) or greater than 120 fps (e.g., a video device capturing high speed objects or a scene that may benefit from slow-motion playback).

Other (user) configurable characteristics may include the heading or direction a video device is directed toward or the light spectrum being sensed (e.g., color, black-and-white, infra-red, or a combination).

In some embodiments, a video device characteristic may be affected by both inherent degradation as well as by user configuration. For example, a video device may be configured to capture at a particular frame rate (e.g., 30 fps). However, the video device may be located in an area that receives significant sunlight during the day causing the camera and image sensor to heat to a particular temperature that causes the frame-rate to at least temporarily degrade to a lower frame-rate than the user configured.

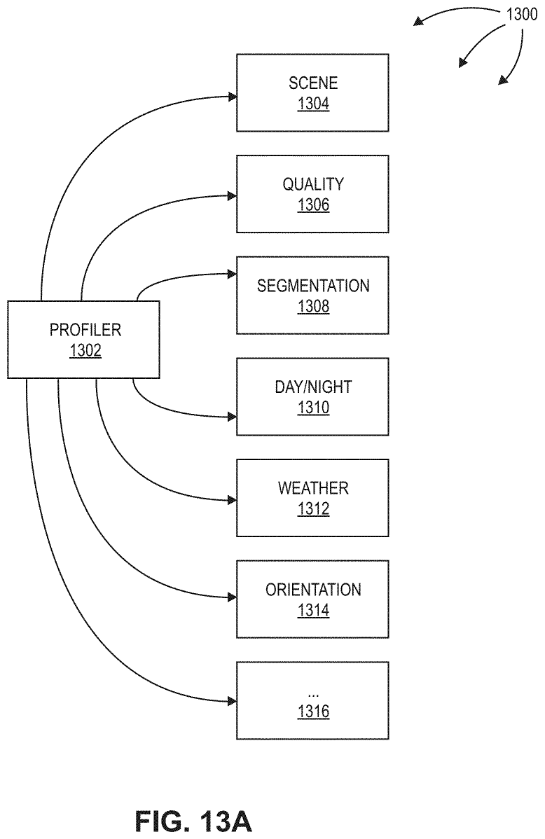

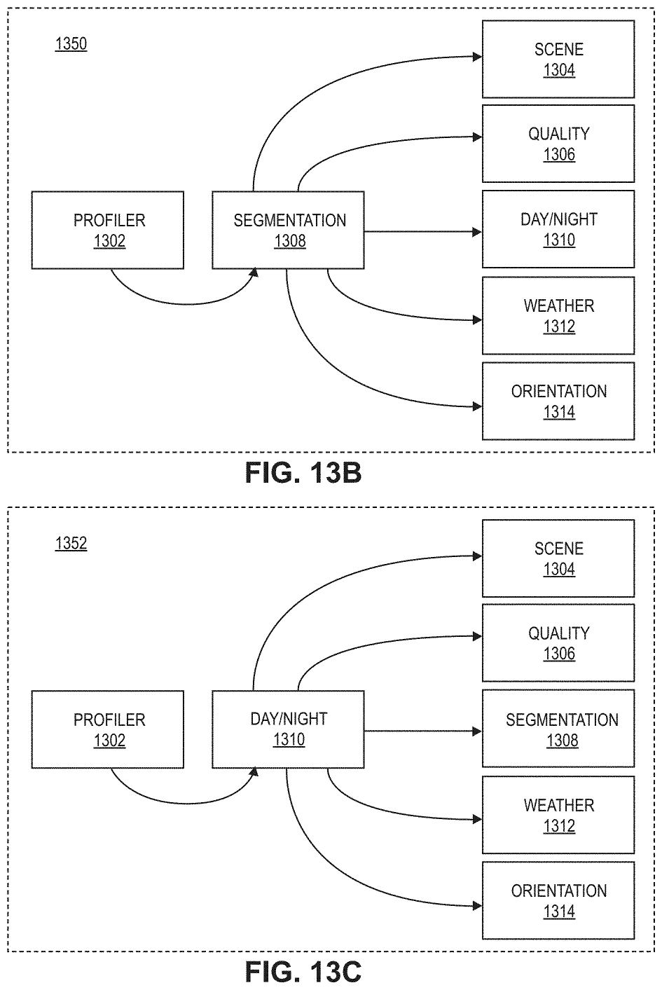

FIG. 13A illustrates an example computer architecture 1300 that facilitates video device profiling. As depicted, computer system 1300 includes profiler 1302 (which can interoperate with, be including in, and/or integrated with profiler/calibrator 1012). Profiler 1302 can include a plurality of profiling objectives that can be run against the output of a video device, such as, a camera 1102. For example, based on the output of the camera 1102, profiler 1302 can determine one or more of: scene 1304, video quality 1306, focus segmentation profile 1308, day/night status 1310, weather 1312, and/or orientation 1314 for the camera 1102. Ellipsis 1316 indicates that profiler 1302 may be configured to determine any number of additional profile characteristics based on output of the camera 1102.

Scene 1304 can be used to identify a profile for the type of objects that are being captured by a video device (e.g., 1102). For example, scenes may include urban environment, highway, intersection, building interior, parking garage, forest, etc. Profiling scene 1304 can include identifying a combination of scene types. For example, “urban environment” and “intersection” may be identified when the output of the video device is determined to include intersecting roads in the proximity of tall buildings.

FIG. 14A illustrates an example video output frame 1401 (e.g., of scene 1304). Frame 1401 can be a single frame of video output received from a camera 1102. As depicted, frame 1401 includes a field of view of an outdoor scene. Profiling scene 1304 can include identifying objects within the scene and making determinations from those elements to determine the nature of the scene. Objects can be identified using object recognition, machine learning, artificial intelligence, or other computational resources to determine the nature of the scene. For example, objects including trees 1422, clouds 1424, mountains 1426, roadway 1428, etc. can be identified in frame 1401. From these objects, it can be determined that frame 1401 includes an outdoor scene. Profiler 1302 use the determination (as well as other determinations) to populate profile data for scene 1304.

Additional assumptions, conclusions, determinations, etc. can be made with respect to 1304. For example, a determination that scene 1401 is outdoor may also include a determination that day/night 610 is relevant and/or that weather 612 is relevant. On the other hand, if an indoor scene is identified, day/night and/or weather may be determined to be less relevant.

As described, a scene and/or video output frame can include multiple scene types. For example, frame 1401 can also or alternatively be categorized as a “roadway” scene, a “highway” scene, a “rural” scene, or the like. Some scene types may be relevant in some instances but discarded or ignored in other instances.

FIG. 14B illustrates another example video output frame 1402 (e.g., of scene 1304). Frame 1402 includes some of the same elements as frame 1401, including trees 1422 and road 1428. However, it may be determined that frame 1402 is less focused on roadway 1428 and more focused on trees 1428. Consequently, frame 1402 may be characterized as a forest scene (e.g., used with fire detection pipelines) rather than a highway scene (e.g., used with traffic monitoring pipelines).

Alternatively, and/or in combination, secondary data can be used to make additional scene determinations. For example, frame 1402 can be categorized as a “forest” scene based on analysis of the depicted field of view (e.g., from a video device, for example, 1102) that produced frame 1402. However, secondary data (e.g., included in other information) may indicate that a video device (e.g., 1102) is part of a system of traffic cameras and should be returning frames focused on roadway 628. Thus, it may be that a scene determination (categorization) conflicts with secondary data indications. Various actions can be implemented to resolve conflicting determinations, including moving a video device.

Quality 1306 can indicate one or more characteristics of output video data, such as, resolution, color presence, color fidelity, sharpness, blur, clipping, other video characteristics, etc. In some embodiments, each sub-element may be individually scored, and their scores aggregated to form quality 1306. In other examples, multiple quality scores may be generated based on different combinations of the sub-elements. For example, profiler 1302 may generate a color quality score and a non-color (e.g., black and white) quality score for the same video device. Multiple quality scores may be beneficial because one pipeline may utilize non-color (e.g., black and white) video data (e.g., a pipeline that determines traffic congestion), while another pipeline utilizes color video data (e.g., a pipeline that for tracking a particular vehicle based on color). As such, a non-color quality score can be used for pipelines that utilize non-color video data while the color score can be used for those pipelines that utilize color video data.

Other elements within color may be treated universally. For example, low resolution may always result in a lower quality score for a video device than a video device with higher resolution (and other things being equal).

FIG. 14C illustrates a further example video output frame 1403 (e.g., of scene 1304). Frame 1403 is roughly the field of view of frame 1401 from FIG. 14A. Frame 1403 also includes inset 1434. Inset 1434 represents a relative field of view of a lower resolution video device as compared to a higher resolution video device that produced frame 1403. That is, frame 1403 is an example of a higher resolution frame, while inset 1434 a lower resolution frame that may be produced. Generally, by determining the pixel dimensions of inset 1434, a resolution for frame 1403 can be determined. For example, frame 1403 may be 1920 pixels wide by 1080 pixels tall. On the other hand, inset 1432 may be 480 pixels wide by 360 pixels tall.

As depicted in FIG. 14C, a reduction in the resolution capability of a video device can cause a corresponding reduction in field of view. The reduced field of view may cause the output of the video device to be much less helpful in some scenarios. For example, the amount of roadway within the field of view in inset 1434 is roughly ⅓ of the field of view of frame 1403. Consequently, inset 1434 may be recognized or categorized as being lower quality.

In other scenarios, rather than reducing the field of view, a lower resolution device may be trained on a larger field of view (e.g. frame 1403). However, if pixel dimension is not proportionally changed, the resulting frame may be blurry and lack detail. As such, quality 606 may be determined from a provided frame in numerous ways including determining the practical effectiveness of a present field of view, or by analyzing the quality of the frame in terms of known characteristics such as blur, sharpness, or the like.

Day/night 1310 may be determined by profiler 1302 as a binary condition. For example, based on a current video output sample, profiler 1302 may determine that a video device is currently operating in daylight conditions or in night-time conditions. Some pipelines may utilize broader scene illumination in order to be effective. As such, an indication of daylight or night-time conditions can be useful in determining whether or not to send video output data to pipelines utilizing broader illumination.

In some examples, day/night 1310 determination may be ascertained for a video device indirectly. As mentioned earlier, some inherent characteristics of a video device may not be reliable over time. However, in the case of general location (e.g., address, zip code, GPS coordinate, etc.), even a rough approximation should be sufficient to determine whether the video device is currently experiencing daytime or nighttime conditions by checking the known location against a time of day for the location.

Day/night 1310 may also be checked using both indirect metadata as well as sampling to determine whether the video device is outputting valid video data. For example, day/night 1310 is determined by analyzing sample output from the video device to determine if the output indicates a night-time scene. The determination can be cross-checked against metadata for the video device location to confirm the analysis. If the cross-check matches, a day/night 1310 determination can be confirmed. If, however, the indirect information indicates the video device should be outputting a day-time scene, profiler 1302 may determine that the quality 1306, scene 1304, orientation 1314, or some other characteristic of the video device is of low-quality or otherwise problematic.

FIG. 14D illustrates an additional frame 1404 that is essentially identical to frame 1402 from FIG. 14B. However, rather than being a day-time scene, frame 1404 is depicted as a night-time scene. Accordingly, day versus night can be determined based on analysis of actual video output. As depicted, FIG. 14D also includes histogram 1438. Histogram 1438 may be generated based on the content of frame 1404 (but is not an element within the frame 1404).

Histogram 1438 indicates a luminance or lighting profile for frame 1404. In one aspect, a frame luminance profile is based on an 8-bit luminance allowing for 256 luminance levels. The levels can then be “binned” to collect/count ranges of pixel luminance levels. For example, a first bin may include a count of pixels in frame 1404 that have a luminance value of between 0 and 25. Bin two may include a count of pixels in frame 1404 that have a luminance value of between 25 and 50. Similar ranges may be used for bins 3 through 10 such that multiple (and potentially all) possible luminance values within frame 1404 can be binned.

Based (at least in part) on histogram 1438, profiler 1302 can determines day/night 1310 for frame 1404. For example, frame 1404 may be considered a night scene when a number (set) of lower luminance bins (e.g., bins 1 and 2) contain greater than a defined amount or percentage (e.g., 20%) of the pixels in frame 1404. In another aspect, night may be determined when a number (set) of higher luminance bins (e.g., bins 8, 9, and 10) contain less than a defined amount or percentage (e.g., 10%) of the pixels in frame 1404. As such, “on the ground” information can be used to determine whether a scene includes sufficient illumination for effective use of a pipeline. Profiler 1302 can consider histogram based day/night determinations alternatively and/or in combination with geographic location-based day/night determinations.

Histogram 1438 can also be binned in different ways. Different bin set thresholds can indicate sufficient (or insufficient) luminance for a pipeline. Additionally, multiple video output frames may be sampled over time and their associated histograms compared. In this way, profiler 1302 can consider histogram trends (changes), for example, increasing or decreasing scene illuminance over time. Histogram trends can represent a transition from night to day (i.e., increasing illuminance over time) or a transition from day to night (i.e., decreasing illuminance over time).

In some aspects, additional luminance categories (in addition to day or night) can be determined. For example, profiler 1302 can determine dusk or dawn based (at least in part) on pixel illuminance binning in histogram 1438. Profiler 1302 can also determine additional luminance categories through histogram profiles, histogram trends, and/or through look-ups relating to the time, location, heading, etc., of a video device. Thus, device profiling can be further augmented by determining more precise lighting characteristics than the binary condition or day and/or night.

Profiler 1302 can also determine weather 1312, for example, by identifying characteristics within a sampled video frame that are representative or indicative of weather such as rain, snow, wind, lightning, etc. For example, profiler 1302 can be configured to identify the relative movement of falling snow as compared to the essential static location of other objects in the frame. In another example, profiler 1302 may identify rain by comparing the luminance in a current frame of a scene (or portion thereof) to the luminance in a prior frame of the scene (or the portion thereof) at a time known to be dry. In further example, profiler 1302 can detect wind based on movement of objects within the frame identified as trees, bushes, flags, etc.

Profiler 1302 can also confirm and/or augment weather 1312 using secondary data linked to the location where the camera is located. For example, if secondary data associated with a location indicates a rain storm and observed video output at the location is blurry, profiler 1302 can consider the secondary data confirming of a rain storm at the location. On the other hand, if secondary data associated with a location indicates clear weather and observed video output at the location is blurry, profiler 1302 can consider other causes for blurriness (e.g., another characteristic of the device, such as, quality 1306 has degraded).

Profiler 1302 can also determine orientation 614 for a video device. Orientation may be determined relatively and/or absolutely. For example, profiler 1302 can determine relative orientation of the video device based on elements within the scene as compared to elements within a prior orientation or a known orientation. Relative orientation may be particularly beneficial when viewing a roadway to determine which direction along the road the video device is pointed. Relative orientation may be aided by environmental elements such as sun position, shadows, or other elements that can be predicted based on time of day. For example, if shadows within the scene are moving left to right in the frame later in the day during the summer, the video device may be determined to be generally oriented in a northernly heading, whereas if the shadows move right to left, the orientation may be determined to be southernly.

Profiler 1302 can determine absolute orientation based on relative orientation techniques in conjunction with profiling other data associated with the video device. For example, for a camera that can be re-oriented by a user using positioning controllers (e.g., rotation and pitch controllers), the values of that positioning relative to a home position may be used. As previously discussed, if there is a conflict between the analysis of the actual output of the device and secondary information received from the device, profiler 1302 may take additional actions to attempt to identify which of the data sources is potentially sending inaccurate or incomplete information.

FIG. 14E illustrates another additional example video output frame 1405. Frame 1405 depicts a scene related to frame 1402 in FIG. 14B. However, the orientation of frame 1405 is altered relative to frame 1402. As described, profiler 1302 can determine the orientation of a video device based on elements within the frame 1405 that are known, recognized, or otherwise understood. For example, the position of the sun within frame 1405 during a known time can provide profiler 1302 evidence to determine orientation. In another example, elements such as visible road signs may be recognized and interpreted to aid in orientation detection.

In some aspects, relative orientation as compared to a prior orientation may also be helpful. In one example, profiler 1302 can determine relative orientation by identifying common elements between two frames and then determining a distance between them. For example, tree 1442 may be identified within frame 1405 and compared to known similar objects in a prior frame, for example, one of trees 1422 in frame 1402. Based on identifying commonality between objects, profiler 1402 can calculate the relative change within the frames to derive how the video device orientation has been altered between the frames.

In some embodiments, profiler 1302 can consider a relative change against a different known orientation to arrive at the current orientation. For example, it may be that an initial orientation is known to have a NNE heading and an object previously in the far left of the frame is now in the far right of the frame. As such, profiler 1302 can determine that the video device orientation has been rotated in a generally SSW direction. Similarly, if an object was previously near the top of a frame and is now nearer the bottom of the frame, profiler 1302 can determine that the pitch orientation of the video device has been altered. Profiler 1302 can consider combinations of rotation and pitch orientation changes, etc.

As described, when considering a video stream, it may be that some portions of the video stream are less relevant (and possibly irrelevant). For example, in a traffic camera video stream, portions including roadway may be more relevant and portions not including roadway may be less relevant. However, full frames of the video stream may none the less be processed even through portions of the frames are of limited (if any) relevance. Processing portions of a video stream having limited relevance is an inefficient use of resources. Processing portions of a video stream having limited relevance also makes tasks (e.g., event detection) more complex/difficult as there is more information to process and understand.

Thus, and also as described, aspects of the invention segment video stream frames. In one aspect, video stream frames are segmented into more relevant segments (e.g., including roadway) and less relevant segments (e.g., not including roadway). Different segments can be handled differently. For example, more relevant segments can be processed to identify vehicles, identify events, etc. and less relevant segments may be ignored. Accordingly, resources can more efficiently utilized.

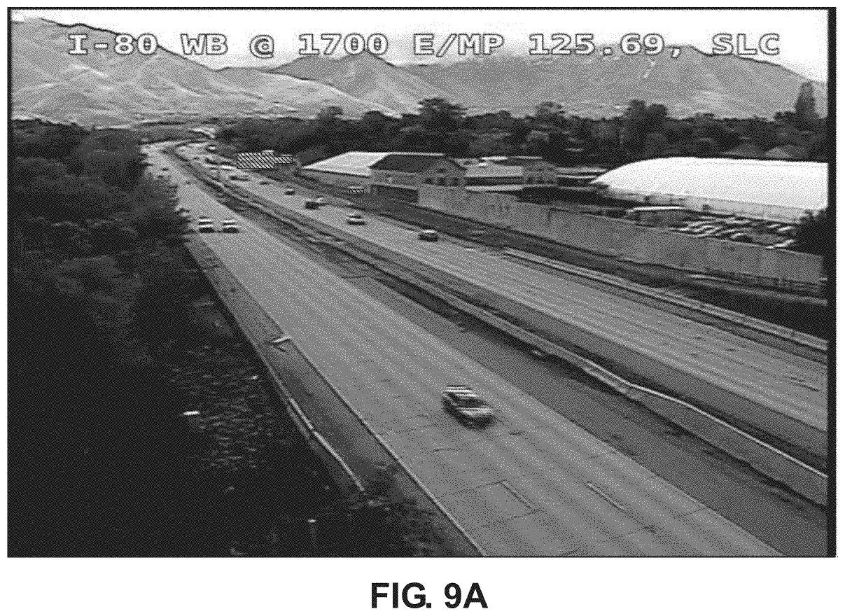

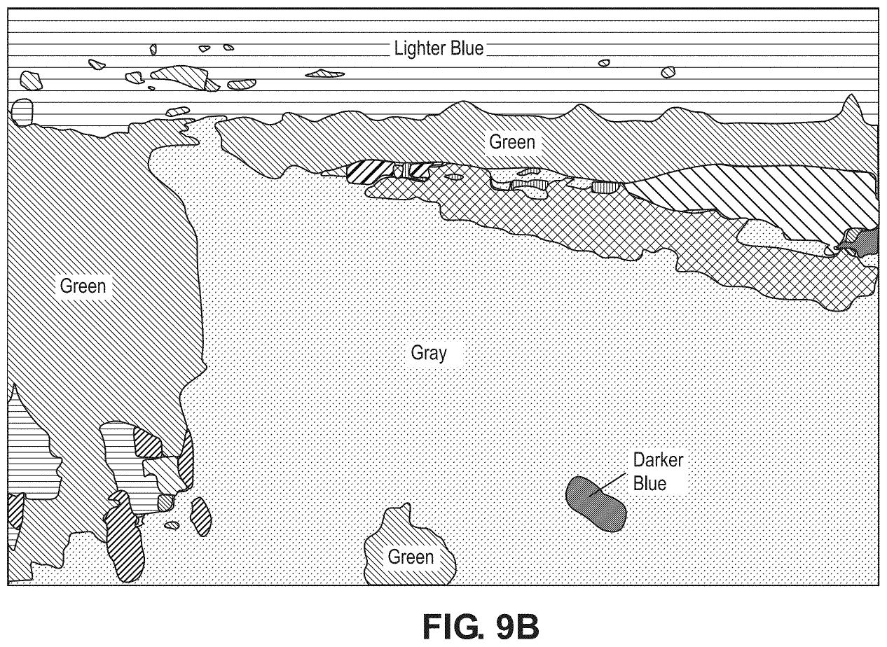

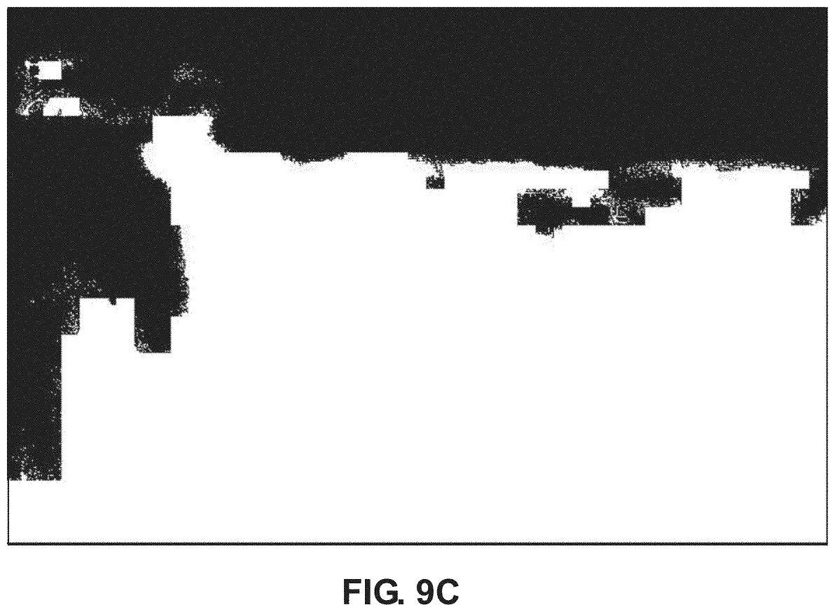

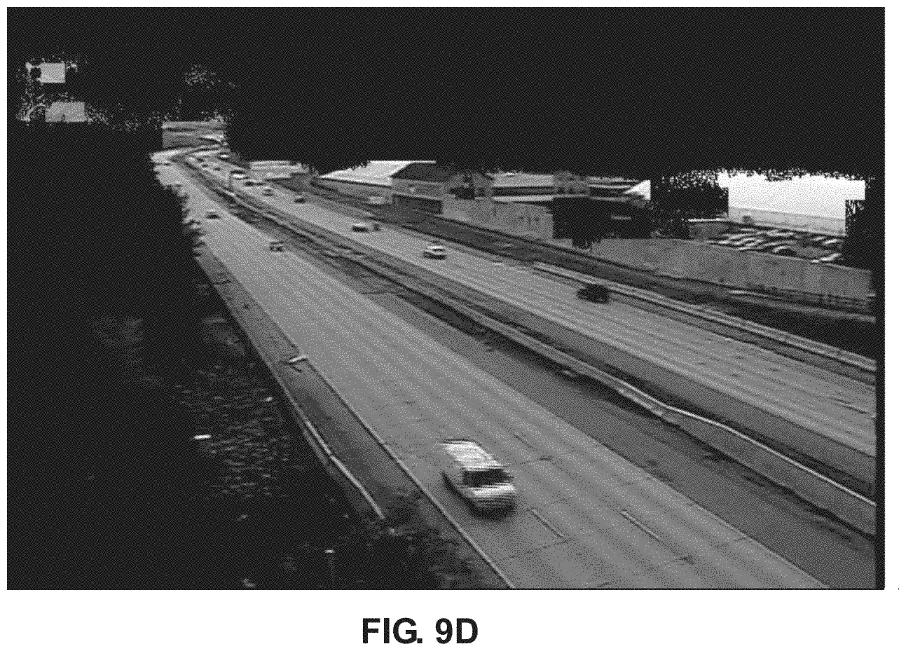

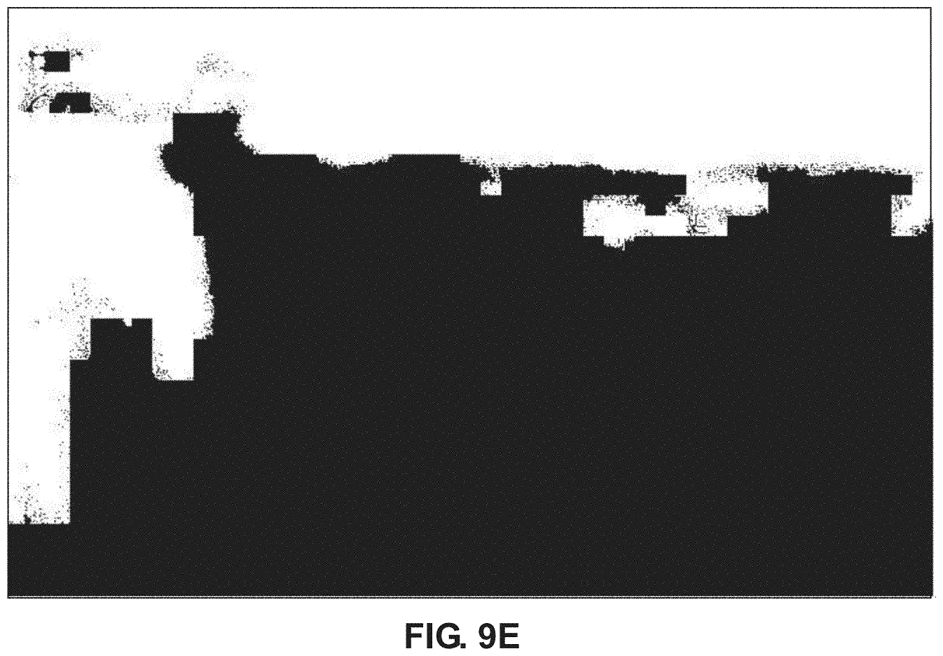

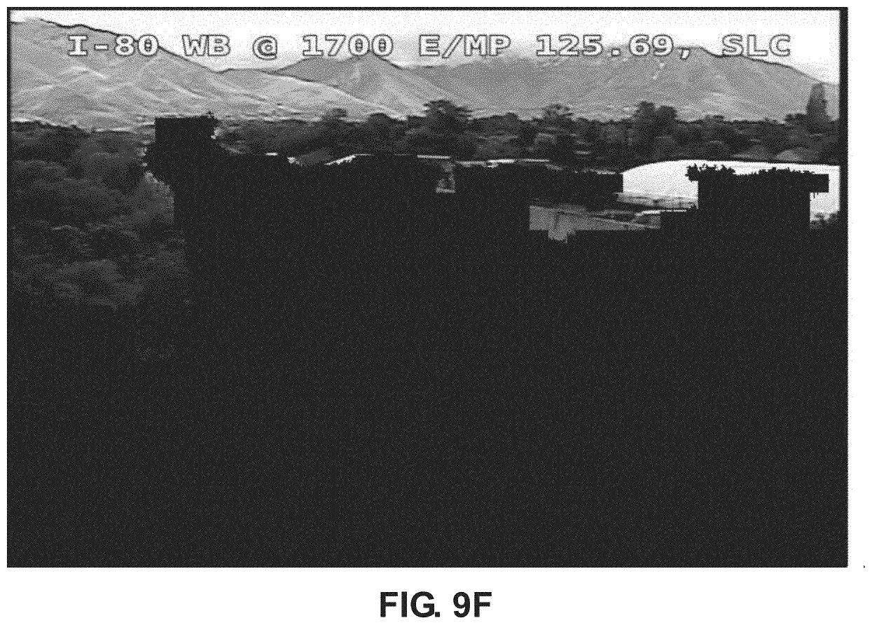

In one aspect, profiler 1302 implements segmentation techniques (e.g., described with respect to any of FIGS. 7A-9F) to determine segmentation 1308. Segmentation 1308 may be used to identified portions of a video output frame having increased importance. For example, a traffic camera that is located along a rural highway may be orientated toward the highway to monitor vehicles on the roadway. However, the roadway itself likely does not occupy the entirety of the field of view of the camera. Instead, buildings, mountains, trees, or other elements may occupy those non-road portions. In some instances, those extra objects are of limited, if any, interest and can be ignored.

Determining segmentation 1308 can include identifying which areas of a frame are of interest and then using areas of interest to establish a map or mask that delineates between areas of interest and areas of non-interest.

FIG. 14F illustrates another additional example video output frame 1406. As depicted, frame 1406 includes a segmentation mask 1431 (the diagonal lines). In some aspects, segmentation is facilitated by the described segmenting and/or masking techniques (e.g., described with respect to any of FIGS. 7A-9F). Profiler 1302 can use segmentation mask 1431 to focus profiling on an area (or areas) of interest within frame 1406 rather than on frame 1406 as a whole. For example, profiler 1302 can determine quality 1306 (as well as other profiling aspects) for roadway 1428. Profiler 1302 can ignore other portions of a frame 1406 masked by segmentation mask 1431.

Profile Sequencing

Profiler 1302 may profile video output for each of the above elements in sequence or at the same time (or in any combination). FIG. 13B depicts a partial profiling sequence 1350. Within profiling sequence 1350, profiler 1302 begins by determining segmentation 1308. Profiler 1302 then determines remaining profile (e.g., data) elements (e.g., scene 1304, quality 1306, day/night 1310, weather 1312, orientation 1314, etc.). Other profile elements can be determined in a specific order or unordered. Since segmentation 1308 can reduce, focus, or otherwise change what portions of the video device output are used, determining segmentation 1308 prior to other profiling elements can minimize resource expenditure to determine the other profiling elements.

FIG. 13C depicts another partial profiling sequence 1352. Within profiling sequence 1352, profiler 1302 begins by determining day/night 1310 (or possibly dawn or dusk). Profiler 1302 then determines remaining profile (e.g., data) elements (e.g., scene 1304, quality 1306, segmentation 1308, weather 1312, orientation 1314, etc.). Some pipelines may utilize day-time scenes. If an available set of pipelines associated with a particular camera utilize a day-time scene, it may be beneficial for profiler 1302 to profile for day/night 1310 (dawn, dusk, etc.) prior to determining other profiling elements. If it is determined that the video device is not experiencing daytime conditions, the camera can be excluded for use with a pipeline without expending resources determining the remaining profiles. If, on the other hand, the video device is experiencing daytime conditions, resources can be allocated to determine the remaining profile (e.g., data) elements.

In some embodiments, by ordering specific profiling activities (e.g., segmentation 1308 or day/night 1310) profiler 1302 may reduce the amount of work needed to determine the remaining profile elements. For example, as previously described, segmentation 608 may be utilized in order to identify areas of increased interest and areas of reduced (or non) interest. Remaining profiling determinations can be made in relation to the areas of increased interest within the segmented video output. This may save processing resources as well as produce profiling output that is more relevant (e.g., a profile that is more representative of the areas of interest rather than of the scene as a whole).

FIG. 14G illustrates a further additional example video output frame 1408. Frame 1408 includes a highway 1328 in a rural area. With frame 1408, highway 1328 (and perhaps areas relatively close to highway 1328) may be relevant to potential pipelines. During night-time, highway 1328 may be illuminated by roadway lights 1382 while the surrounding area is dark. As such, profiler 1302 may determine that day/night 610 returns night (e.g., based on an overall scene histogram, such as, histogram 1438) disqualifying frame 1408 from some pipelines. However, based on illumination from lights 1382, roadway 1328 may be sufficiently illuminated for some pipelines. As such, partial profiling sequence 1350 can be beneficial for frame 1408.

In one aspect, histogram 1484 is generated for roadway 1628 (a segment of interest and as opposed to the full frame 1408) subsequent to determining segmentation 1308. Because roadway lighting 1482 is focused on road 1428 (a segmented portion), histogram 1484 may then quantify and bin pixel luminance values for pixels included in road 1428. As depicted, the resulting histogram 1484 indicates a greater proportion of higher-luminance binning (as compared to histogram 1438). For example, bin 7 and bin 8 contain a higher percentage of pixels while bins 1 through 3 contain a lower percentage of pixels. Thus, day/night 1310 may become more of a representation of adequate lighting or luminance within a segmented area of interest in a frame.

Utilizing partial profiling sequences can create conflicts between an observed value of day/night 610 and secondary data known about a camera. For example, when profiler 1302 determines day/night 1310 for illuminated roadway 1428 (as opposed to the entirely of frame 1408), it may appear as if it is day even though secondary data would suggest it is night-time. As such, profiler 1302 may determine that day/night 610 for frame 1408 can be ignored if “day” is identified for a segmented an area of interest, even when night is expected. On the other hand, the reverse conflict may not be ignored as observing dark video output when day is expected may indicate faulty or degraded equipment, an abnormal weather event, or some other profiling anomaly.

Profiling Intervals

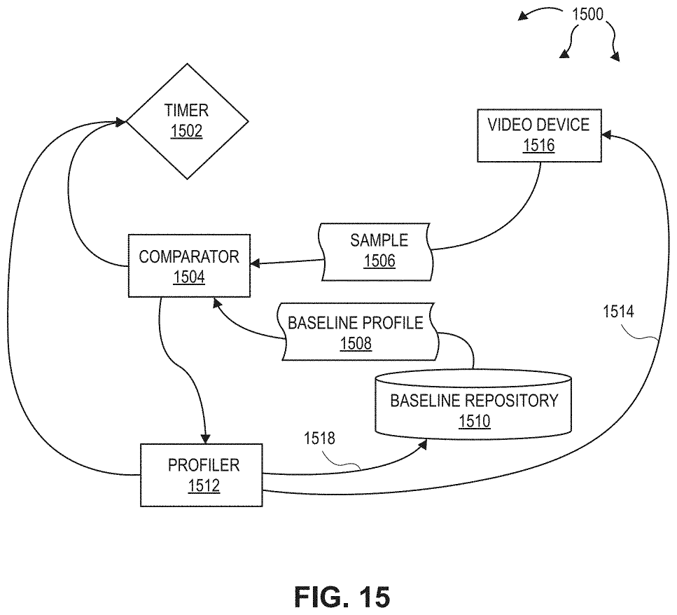

FIG. 15 illustrates an example computer architecture 1500 that facilitates profiling at intervals. As described, the present state of a video device may not be accurately determined simply by reviewing or analyzing static information about the device. Instead, it may be beneficial to periodically sample actual output from the video device and analyze that output to more accurately determine a state of the current output of the video device.

In some instances, video devices can be automatically profiled at designated intervals. A profiling interval can be selected based on a location, a device type, or on some other detail. For example, a video device known to be installed in an area that experiences frequent rain may have a shorter automatic profiling interval than a device installed in an area that usually has more mild weather. In another example, a device that allows user-manipulation (e.g., orientation control) may have a shorter interval than a device that is statically positioned.

As depicted, computer architecture 1500 includes timer 1502, comparator 1504, baseline repository 1510, profiler 1512 (e.g., profiler 1302), and video device 1516 (e.g., a video device 1102). Timer 1502 can be configured as a countdown timer such that timer 1502 triggers at specified intervals of seconds, minutes, hours, or days. For example, timer 1502 may be configured to trigger every 4 hours. In other aspects, timer 1502 may be configured with more complex scheduling rules. For example, timer 1502 may be configured to trigger every Monday morning at 5:00 am, every Wednesday evening at 9:00 pm, and every Saturday morning at 6:00 am. These schedules may be selected to coincide with other known events such as shortly before the beginning of commuter traffic for the work week, or some other type of event.

In some aspects, timer 1502 may be configured to trigger at an interval that is linked to the occurrence of some other event. For example, a series of video devices may include a timer 1502 that is set to trigger at some interval after a prior video device in the series completes profiling.

When timer 1502 is triggered, comparator 1404 receives a sample 1506 (e.g., one or more frames, sprites, vectors, etc.) from video device 1516 (a video device 1102). For example, sample 1506 may comprise raw video data from a video device, such as, a collection of sprites 1106. Sprites 1106 may include a current (or near current) set of raw frames output from video device 1516 according to its present output capability.

Comparator 1504 additionally receives a baseline profile 1508 for video device 1516 from baseline repository 1510. Baseline profile 1508 may include a frameset or set of sprites collected from video device 1516 at some point in the past. Baseline profile 1508 may represent a “known-good” output for video device 1516 such that it represents a most recent output profile or capability of video device 1516. In some embodiments, more than one baseline profile may be available for a video device within baseline repository 1510. In such instances, timer 1502 may include additional details associated with the profiling interval such as which of the more than one baseline profiles should be selected.

Comparator 1504 performs one or more functions to compare the present sample 1506 to the baseline profile 1508 of video device 1516. For example, comparator 1504 may compare the sample 1506 and baseline profile 1508 to determine whether there is a match between resolution, color fidelity, orientation, scene, quality, etc. Comparator 1504 can then whether whether—and/or to what degree—sample 1506 matches baseline profile 1508. A degree of match may be compared against a static threshold, percentage change, or some other metric to determine whether a match quality between sample 1506 and baseline profile 1508 is sufficient to consider sample 1506 of the same (or sufficiently similar) quality as baseline profile 708.

If the match quality is insufficient (i.e., sample 1506 is lower quality), comparator 1504 may trigger 1514 profiler 1512 to execute profiling of video device 1516. Subsequent to profiling, profiler 1512 may add the new profile 1518 to baseline repository 1510 as a new baseline profile for video device 1516. The new baseline profile can replace or be stored along with exiting profiles for video device 1516. The new profile can also be marked with additional details about the profiling (e.g., timestamp, orientation, etc.) that may aid in informing the context of the profiling.

Profiler 1512 can inform timer 1502 that the profiling interval is complete. In some aspects, such as, when timer 1502 is based on a count-down, notification from profiler 1512 resets timer 1502. In other embodiments, a profiling sequence may end with profiler 1512 and/or timer 1502 reset without direct notification.

In general, profiler 1512 may be analogous to (or contained within) profiler 1012 and/or profiler 1302. Similarly, baseline repository 1510 may be analogous to (or contained within) camera metadata repository 1006. Thus, profiler 1512 may populate baseline repository 1510 with data or metadata representing the profiling characteristics of video device 1516. Those data and/or metadata may then be used to determine one or more pipelines that can be executed against the output of video device 1516. For example, pipeline repository 1008 may include the data—or be derived from the data—generated by profiler 1512 for video device 1516.

Seeding Metadata Repository

FIG. 16 illustrates an example computer architecture 1600 that facilitates seeding camera metadata repository 1006. Each camera can be identified by a camera ID 1602. Repository 1006 can then store data against camera ID 802 such as one or more reference frame sets 1604, one or more pipeline confidence scores 1606, one or more calibration score 1608, and one or more camera details 1610.

Reference frame set 1604 may comprise one or more master frames or sprites collected from the video device with camera ID 1602. Reference frame set 1604 may have been collected at initial configuration of a video device or during a subsequent reference frame collection (e.g., during a subsequent profiling sequence). Reference frame set 1604 may be directly stored within repository 1006 or it may be stored referentially against camera ID 1602 such that it can be accessed either directly or indirectly through repository 1006.

One or more pipeline confidence scores 1606 may also be stored against camera ID 1602. As described, based on profiling a video device, one or more confidence scores may be generated representing a confidence that particular video device can produce valid/sufficient output for a given pipeline category. For example, a pipeline confidence score may include a pipeline category identifier (e.g., “CART”) along with a confidence value representing the degree of confidence the pipeline category can be executed using output from the video device. In one example, the pipeline confidence score for a given pipeline category is a numerical value representing an aggregation of the various profile scores 1608.

Underlying profiling/calibration scores 1608 may be directly stored against camera ID 1602 and may also be used as at least part of the basis of the pipeline confidence scores. Storing profile scores 1608 independently from (or in addition to) pipeline confidence scores 1606 may allow a new pipeline to receive a pipeline confidence score for the camera without requiring immediate profiling. That is, when a new pipeline is developed, camera metadata repository 1006 may be utilized to determine individual profile scores 1608 associated with the new pipeline. Use of profile scores 1608 can be extended by then creating a new pipeline confidence score 1606 for the new pipeline and storing that against the camera ID 1602.

Additional camera details 1610 may also be stored against camera ID 1602. Additional details may include baseline configuration information for the associated video device (e.g., installation location, entity information, available user controls, time in service, etc.). Additional information may be relied on by the profiling/calibration services for various purposes.

Model Zoo

In another aspect, multiple pipeline versions may exist for a given pipeline. For example, a CART pipeline may include both a “high” and a “low” version where the high version has increased requirements from the video output than the low version does. Resolution, color presence or fidelity, or framerate may be some examples of video characteristics that may be different between or among different versions of the same pipeline.

When there are multiple versions of a pipeline, the versions may be stored together and distinguished using an identifier. For example, the “CART HIGH” 1008a and “CART Low” 1008b entries discussed in conjunction with pipeline repository 1008. Additionally, each of the versions may include a different required confidence value. Using the CART High and CART Low example, CART High may be given a numerical confidence value that is higher than a numerical confidence value assigned to the CART Low pipeline version. This confidence value may be used to represent a quality or minimum threshold that a video device output is to have in order for output of the video device to be used as input to that pipeline version.

To accommodate this feature, when video output is profiled for a given video device, an analogous confidence value may be calculated and applied to the video device that created the output. For example, based on an aggregate of one or more profile scores (e.g., profile scores 1608 generated by profiler 1012, 1302, or 1512), a confidence value may be assigned to the video device and stored within camera metadata repository 1006 against a camera ID for the video device. The confidence value may be the pipeline confidence score described. In other embodiments, the confidence value is derived from, but separate from the pipeline confidence score(s) 1606.

As described, each video device may have one or more pipeline confidence scores stored against a camera ID in the camera metadata repository 1006. The confidence value concept may extend the pipeline confidence scores by including the confidence value along with the pipeline confidence scores. This may be done at a pipeline category level rather than at the pipeline version level. For example, a particular camera ID 1602 may include a listing for a particular category of pipeline, such as CART. Along with that category, an associated confidence value may be included for the device associated with that camera ID 1602. For example, a record may be stored against the camera ID for “CART 12,” where the confidence value 12 represents a version/confidence level of the associated pipeline the video device is capable of achieving for that particular pipeline category.

When a CART pipeline is requested to be run using output from a particular video device, an entry for the camera ID 1602 of that video device may first determine if the video device can provide sufficient output for the pipeline category (e.g., CART) and then determine what level/version of that category the video device has been assigned using the confidence value. In some embodiments, the highest/best compatible pipeline version can then be selected and run against the video device output.

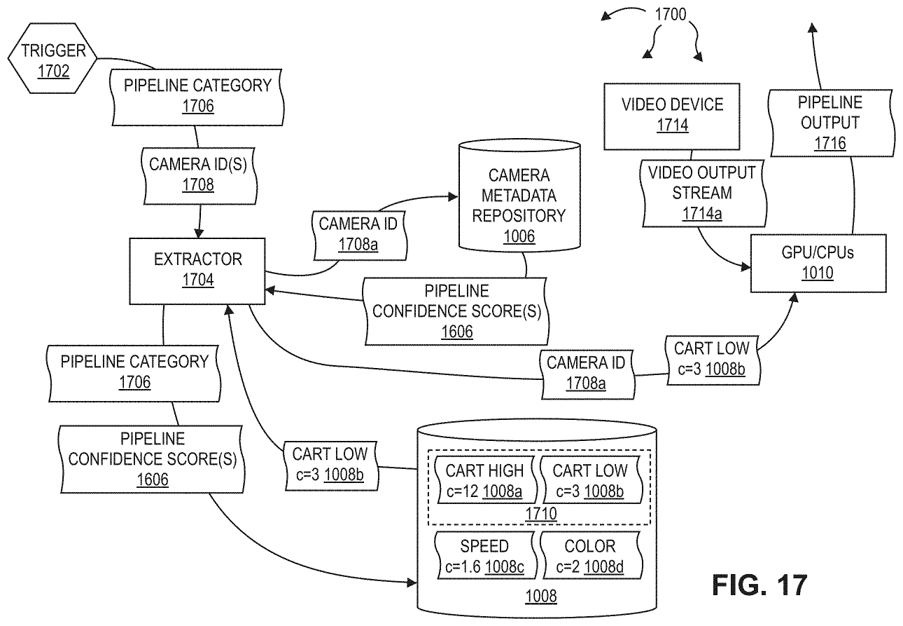

Turning to FIG. 17, FIG. 17 illustrates an example computer architecture 1700 that facilitates producing output from a pipeline. Trigger 1702 can send pipeline category 1706 and camera Id(s) 1708 to extractor 1704. Camera Id(s) can identify corresponding video devices that the requested pipeline category 1706 should be executed against. For example, pipeline category 1706 may include an indication that the “CART” pipeline should be run against output from a set of video devices with camera Ids 908 that range from “0001-0009.”

For each of the received camera IDs 1708, extractor 1704 then determines which, if any, versions of the pipeline category 1706 the particular camera ID has a record for. For example, extractor 1704 may query camera metadata repository 1006 with camera Id 1708a. In response, camera metadata repository 1006 can return pipeline confidence score(s) 1606 (corresponding to camera Id 1708a) to extractor 1704. Pipeline confidence scores 1606 may include a scalar value that represents a confidence level that the video device can execute a pipeline category. Thus, in the present example, the pipeline confidence score 1606 may include a confidence value of “7” for the video device associated with camera ID “0001” when operating a “CART” pipeline.

Extractor 1704 can use pipeline category 906 (e.g., “CART”) and pipeline confidence score 1606 (e.g., “7”) to determine which, if any, pipelines are available for camera Id 1708a. For example, extractor 1704 can query pipeline repository 1008 with pipeline category 1706 and pipeline confidence score(s) 1606. Pipeline repository 1008 can identify a set of available (and compatible) pipelines 1710 (e.g., including 1008a and 1008b) based on pipeline category 1706. Then, using pipeline confidence scores 1606 as a filter against the available pipelines 1710, pipeline repository 1008 can identify an appropriate pipeline. In the present example, pipeline 1008a “CART High” requires a confidence value of “12” while pipeline 1008b “CART Low” requires a confidence value of “3.” Pipeline repository 1008 can determine that the confidence score 1606 (of “7”) satisfies pipeline 1008b but not 1008a. Thus, pipeline repository 1008 can select pipeline 1008b and return pipeline 1008b to extractor 1704.

As such, pipeline 1008b satisfies trigger 1702. Extractor 1704 can send camera Id 1708a and pipeline 1008b to GPU/CPUs 1010. GPU/CPUs 1010 can determine that camera Id 1708a corresponds to video device 1714 (e.g., a camera 1102). GPU/CPUs 1010 can then obtain video output stream 1714a from video device 1714. GPU/CPUs 1010 can execute pipeline 1008b using video output stream 1714a as input. Execution of pipeline 1008b can produce pipeline output 1716.

Video Output Sufficiency for a Pipeline

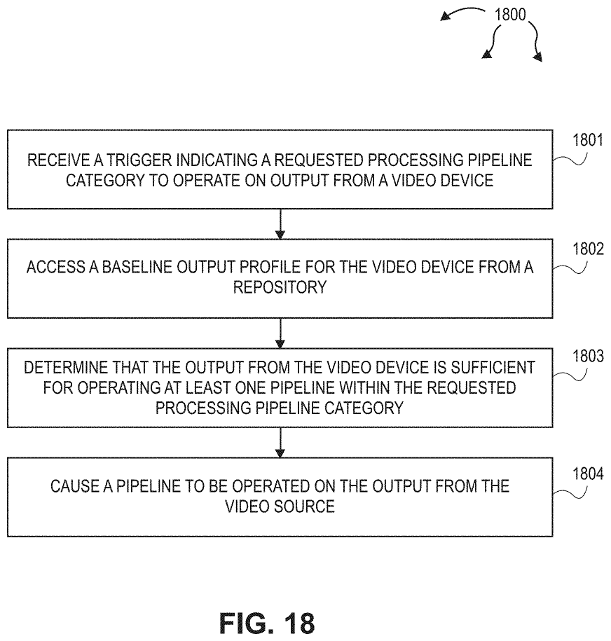

FIG. 18 illustrates a flow chart of an example method 1800 for determining video output device sufficiency for a pipeline. Method 1800 will be described with respect to the components and data in computer architecture 1700.

Method 1800 includes receiving a trigger indicating a requested processing pipeline category that should be operated on an output from a video device (1801). For example, trigger 1702 may be generated and sent to an extractor 1704. Trigger 1702 may include, among other things, a pipeline category 1706. Trigger 1702 may additionally include one or more camera IDs 1708 indicating the video outputs trigger 1702 is requesting pipeline processing to occur.

Method 1800 includes accessing a baseline output profile from a repository (1802). For example, extractor 1704 can utilize trigger 1702 (including pipeline category 1706 and/or camera Id 1708a) to query camera metadata repository 1006. Camera metadata repository 1006 can return a baseline profile, including pipeline confidence score(s) 1606, to extractor 1704 for video device 1714 (corresponding to camera Id 1708a.

Method 1800 includes determining that the output from the video device is sufficient for operating at least one pipeline within the requested processing pipeline category (1803). For example, extractor 1704 can query pipeline repository 1008 using the pipeline category 1706 along with pipeline confidence scores 1606. Pipeline repository 1008 can determine that video output from video device 1714 is sufficient to operate pipeline 1008b based on the pipeline category 1706 and pipeline confidence scores 1606. Pipeline repository 1008 can return pipeline 1008b to extractor 1704.

Method 1800 includes causing a pipeline to be operated on the output from the video device (1804). For example, extractor 1704 may send or otherwise communicate to processing GPU/CPUs 1010 that pipeline 1008b is to be operated using video output stream 1714a as input. GPU/CPUs 1010 can then operate pipeline 1008b to produce pipeline output 1716.

Video Device Reprofiling Determination

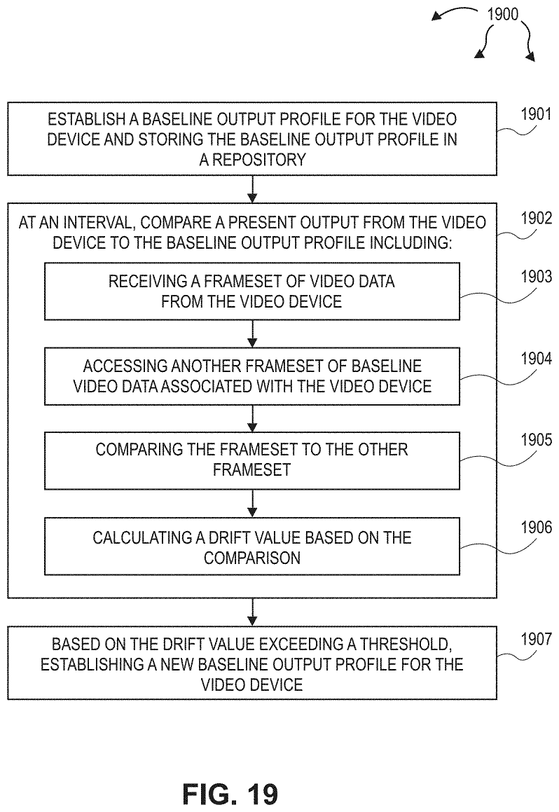

FIG. 19 illustrates a flow chart of an example method 1900 for determining if video device reprofiling is appropriate. Method 1900 will be described with respect to the components and data in computer architecture 1500.

Method 1900 includes establishing a baseline output profile for a video device and storing the output in a repository (1901). For example, profiler 1512 may generate and store baseline profile 1508 for video device 1516 within a repository 1510.

Method 1900 includes, at an interval, comparing a present output from the video device to the baseline output profile (1902). For example, in response to an interval associated with timer 1502, comparator 1504 can compare sample 1506 to baseline profile 1508. The interval can be a scheduled interval or some other interval. In one aspect, timer 1502 generates a signal causing comparator 1504 to begin a calibration sequence.

Comparing a present output from the video device to the baseline output profile can include receiving a first frameset of video data from the video device (1903). For example, comparator 1504 can receive sample 1506 from video device 1516. Comparing a present output from the video device to the baseline output profile can including accessing another frameset of baseline video associated with the video device (1904). For example, comparator 1504 can access baseline profile 1508 from baseline repository 1510.

Comparing a present output from the video device to the baseline output profile can include comparing the frameset to the other frameset (1905). For example, comparator 1504 can compare sample 1506 and baseline profile 1508. Comparing a present output from the video device to the baseline output profile can include calculating a drift value based on the comparison (1906). For example, comparator 1504 can calculate a drift value based on the comparison between sample 1506 and baseline profile 1508. The drift value can indicate difference in video quality of sample 1506 relative to video quality in baseline profile 1508.

Method 1900 includes, based on the drift value exceeding a threshold, establishing a new baseline output profile for the video device. For example, the drift value based on the difference in video quality of sample 1506 relative to video quality in baseline profile 1508 can exceed a threshold. Based on the drift value exceeding the threshold, profiler 1512 can establish a new baseline output profile for video device 1516 (e.g., based on the difference in video quality). Profiler 1512 can store the new baseline output profile in baseline repository 1510

Applying Partially Sequenced Video Profiling

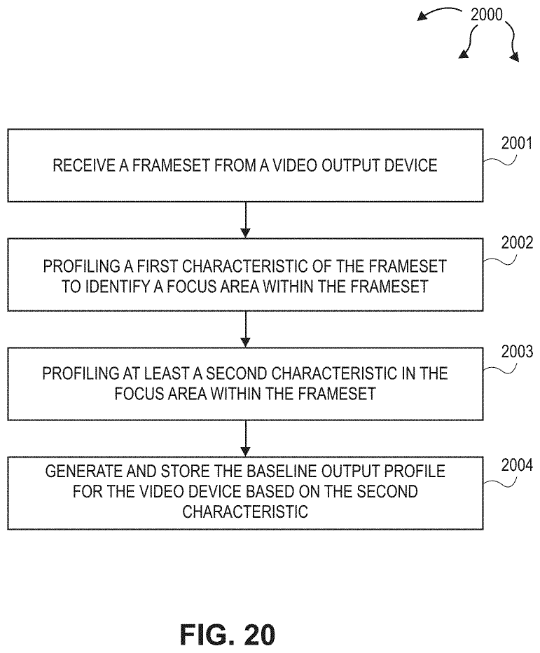

FIG. 20 illustrates a flow chart of an example method 2000 for applying a partially sequenced video profiling. Method 2000 will be described with respect to the components and data in computer architecture(s) 1300/1350.

Method 2000 includes receiving a frameset from a video output device (2001). For example, profiler 1302 may receive video device output in the form of frames, master sprites, or other appropriate frameset format (e.g., 1104, 1106, or 1108). Method 2000 includes profiling a first characteristic of the frameset to identify a focus area within the frame set (2002). For example, profiler 1302 may execute/apply segmentation 1308 to the received frameset to generate a focus map within the received frames identifying at least some areas of non-interest (and some areas of interest) within the frame.

Method 2000 includes profiling at least a second characteristic in the focus area within the frameset (2003). For example, profiler 1302 can apply one or more of scene 1304, quality 1306, day/night 1310, weather 612, and/or orientation 614 to the areas of interest within the frameset produced through segmentation 608 (and can ignore areas of non-interest. Method 2000 includes generating and storing a baseline output profile for the video device based on the second characteristic (2004). For example, profiler 1302 can generate a baseline profile based on the one or more of: one or more of scene 1304, quality 1306, day/night 1310, weather 612, and/or orientation 614. Profiler 1302 can store the baseline profile for the video device (e.g., in baseline repository 1510)

Applying Mutual Exclusive Profile Conditions

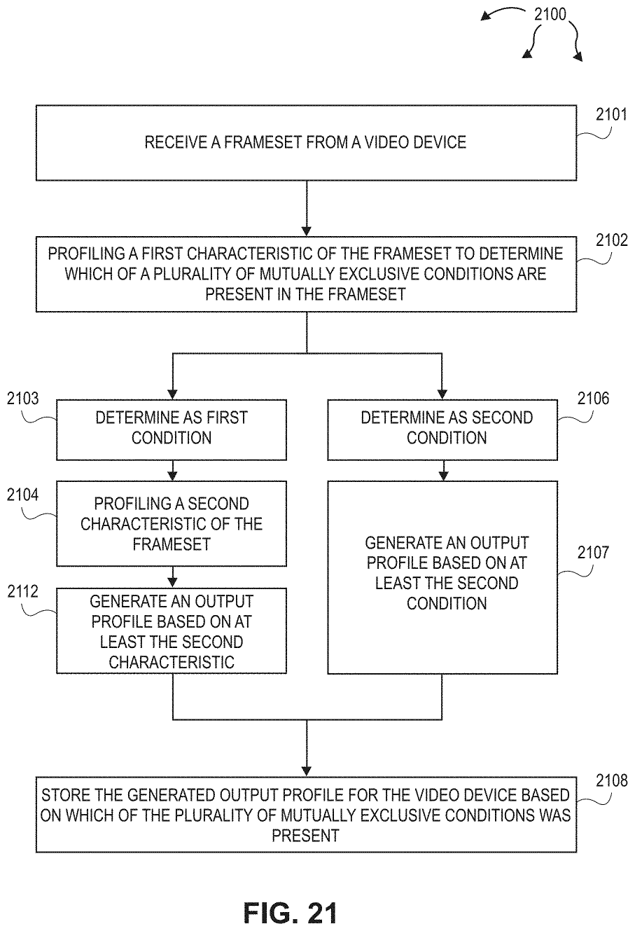

FIG. 21 illustrates a flow chart of an example method 2100 for applying a mutually exclusive profiling condition associated with a video device. Method 2100 will be described with respect to the components and data in computer architecture(s) 1300/1352.

Method 2100 includes receiving a frameset from a video device (2101). For example, profiler 602 may receive video device output in the form of frames, master sprites, or other appropriate frameset format (e.g., 1104, 1106, or 1108).

Method 2100 includes profiling a first characteristic of the frameset to determine which of a plurality of mutually exclusive conditions are present in the frameset (2102). For example, profiler 1302 can apply day/night 1310 to determine if day or night is present in the received frameset. In other examples, profiler 1302 may profile to determine between dawn, day, dusk, or night. Profiler 1302 can also determine other mutually exclusive conditions.

Method 2100 can include determining a first condition (from among the plurality of mutually exclusive conditions) is present (2103). For example, profiler 1302 can determine that a “day” condition is present in the received frameset. Method 2100 can include profiling a second characteristic of the frameset (2104). For example, in response to determination a “day” condition, profiler 1302 can apply one or more of: scene 1304, quality 1306, segmentation 1308, weather 1312, orientation 1314, etc. to the received frameset. Method 2100 can include generating an output profile based on at least the second characteristic (2105). For example, profiler 1302 can generate an output profile based on the one or more of: scene 1304, quality 1306, segmentation 1308, weather 1312, orientation 1314, etc.

On the other hand, method 2100 can include determining a second condition (from among the plurality of mutually exclusive conditions) is present (2106). For example, profiler 1302 can determine that a “night” condition is present in the received frameset. Method 2100 can include generating an output profile based on at least the second condition (2107). For example, profiler 1302 can generate a profile indicating that output from a video device is “night”. Since the frames may not be illuminated well enough, there is a reduced likelihood of further profiling revealing additional useful information. As such, when the second condition is present (in this aspect “night”), resources can be conserved by refraining from additional profiling.

Method 2100 includes storing the generated output profile for the video device based on which of the plurality of mutually exclusive conditions was present (2108). For example, if a “day” condition is determined for the frameset, profiler 1302 can store an output profile indicating the “day” condition as well as one or more of: scene 1304, quality 1306, segmentation 1308, weather 1312, orientation 1314, etc. On the other hand, if a “night” condition is determined for the frameset, profiler 1302 can store an output profile indicating the “night” condition without additional profiling characteristics.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A video output device profiling method comprising:
receiving a frameset from a video output device;
profiling a first characteristic of the frameset;
identifying a focus area within the frameset based on the first characteristic profile;
profiling a second characteristic within the focus area;
generating a baseline video device output profile based at least on the second characteristic profile; and
storing the baseline video device output profile in repository.
